(19) United States
(12) Patent Application Publication
(10) Pub. No.: US 2013/0230482 A1
(43) Pub. Date: Sep. 5, 2013

(54) WATER DISPERSION TYPE SUSTAINED RELEASE PREPARATION FOR RELEASING VOLATILE ACTIVE SUBSTANCE

(71) Applicant: NISSIN CHEMICAL INDUSTRY CO., LTD., Echizen-shi (JP)

(72) Inventors: Ryuichi Saguchi, Joetsu-shi (JP); Takehiko Fukumoto, Joetsu-shi (JP); Masahiko Ikka, Echizen-shi (JP); Kouji Kinoshita, Echizen-shi (JP); Hiroyuki Saitou, Echizen-shi (JP); Yoshihiro Ozawa, Echizen-shi (JP)

(73) Assignee: Nissin Chemical Industry Co., Ltd., Echizen-shi (JP)

(21) Appl. No.: 13/866,450

(22) Filed: Apr. 19, 2013

Related U.S. Application Data
(63) Continuation of application No. PCT/JP2012/078880, filed on Nov. 7, 2012.

(30) Foreign Application Priority Data
Nov. 7, 2011 (JP) 2011-243667

(51) Int. Cl. A01N 25/10

(52) U.S. Cl. CPC A01N 25/10
USPC 424/84; 514/772.4

(57) ABSTRACT

There is provided a water dispersion for a sustained release preparation, the dispersion having viscosity at 25° C. of not more than 100 mPa·s and including polymer particles which are obtained by polymerizing ethylenically unsaturated group-containing monomers (A); at least one kind of a hydrophilic substance (B) in an amount of more than 0% by weight but not more than 20% by weight relative to a total amount of the ethylenically unsaturated group-containing monomers (A), being selected from a group consisting of a surfactant, a plasticizer and a moisturizer; polyvinyl alcohol (C) in an amount of more than 0% by weight but not more than 30% by weight relative to a total amount of the ethylenically unsaturated group-containing monomers (A), having a degree of saponification of more than 82 mol %; and water.

### RELATED APPLICATIONS

This application is a continuation of PCT/JP2012/078880, filed on Nov. 7, 2012, which claims priority from Japanese Application No. 2011-243667, filed on Nov. 7, 2011, the contents of which are incorporated herein by reference in their entireties.

### BACKGROUND OF THE INVENTION

The present invention relates to a water dispersion type sustained release preparation for releasing a volatile active substance. More specifically, the present invention relates to a water dispersion type sustained release preparation for releasing a volatile active substance, the preparation having low viscosity and a sufficient adhesion property suitable for an aerial spray from an aircraft or a helicopter or a ground spray from a vehicle such as a tractor, comprising a volatile active substance and a polymer water dispersion, and continuously releasing the volatile active substance at a constant rate over a long period of time after the spray.

### FIELD OF THE INVENTION

A sex pheromone has been utilized as a method for attracting or disrupting agricultural pests. For example, when the sex pheromone is applied to farmland, agricultural pests are attracted and collected by the sex pheromone. Because a mating ability for sensing or positioning the opposite sex is disrupted, procreation by mating is suppressed. The uniform release is generally attempted by using a sustained release preparation. It is necessary to uniformly release the sex pheromone for a period of not less than six weeks since a mating period of agricultural pests continues over the period. In addition, if the sex pheromone easily drops out owing to rain or wind, the sex pheromone is not uniformly released and the effect is not exhibited.

In the development of sustained release preparations, a sustained release preparation obtained by micro-capsuling a sex pheromone with a cellulose derivative (JP 58-183601A), sustained release preparations obtained by impregnating sex-pheromone-compatible synthetic resin pellets with a sex pheromone substance, pulverizing the pellets, and further coating the surfaces of the pulverized pellets with inorganic powder or granules or a synthetic resin which is not compatible with the pheromone substance (JP 61-92024A), a sustained release preparation obtained by mixing a synthetic resin pellet containing a sex pheromone substance with O/W type acrylic adhesive emulsion and suspending (JP 7-231743A) and the like have been disclosed. In addition, synthetic resin emulsion obtained from a polymerizable monomer having a specific functional group and one or more selected from unsaturated monocarboxylate ester, unsaturated dicarboxylate diester and aliphatic vinyl has been disclosed (JP 60-252403A and JP 61-5001A).

Furthermore, an attempt to solve the above problem by a micro-capsule technology utilizing polymer particles has been made in recent years. For example, a water dispersion type sustained release preparation characterized by comprising a sex pheromone in a micro gel made of a monomer component comprising a (meth)acrylate ester monomer and a multifunctional (meth)acrylate ester monomer is disclosed in JP 2001-158843A. A water dispersion type sustained release preparation having a sex pheromone release inhibitor further mixed is disclosed in JP 2004-331625A. Furthermore, micro-capsuling of a sex pheromone by multi-stage emulsion polymerization is disclosed in JP 2006-35210A. However, the aforementioned problem, particularly the problem of uniformly releasing substantially all of the comprised sex pheromone has not been fully solved in any of the above examples, and also, complicated steps such as pulverization, micro-capsuling and multi-stage polymerization have been required.

In addition, the above-mentioned studies on materials other than the sex pheromone have been conducted. For example, an application of a complex resin of polyurethane and vinyl polymer as a repellent, an antibacterial fungicide and an aromatic is disclosed in JP 2005-290034A. An application of a biodegradable resin including random or block copolyester for fragrance is disclosed in JP 11-106629A. However, the aforementioned problem has not necessarily been solved. Furthermore, a sustained release functional agent in which a functional material and a hydrophobic substance are embedded in a kneaded state in pores of a hydrophilic porous body having many pores which are open in the surface thereof and having a specific surface area of not less than 0.1 m²/g is disclosed in JP 10-17846A. A porous hollow polymer particle having a plurality of cavities therein is disclosed in JP 2009-120806A. However, the aforementioned problem has not been fully solved in any of the above examples, and complicated steps have been required.

### SUMMARY OF THE INVENTION

The present invention has been made in order to solve the problems in the related art, and provides a water dispersion type sustained release preparation for releasing a volatile active substance at a constant rate over a long period of time until substantially all the content of which can be released and which has low viscosity and a sufficient adhesion property.

As a result of an intensive study for achieving the above object, the present inventors have discovered that it is possible to release all the contents of the water dispersion type sustained release preparation for releasing a volatile active substance at a constant rate over a long period of time as described below, and that the preparation has low viscosity and a sufficient adhesion property, and have completed the present invention.

According to the present invention, there is provided a water dispersion for a sustained release preparation, the dispersion having viscosity at 25° C. of not more than 100 mPa·s and comprising polymer particles which are obtained by polymerizing ethylenically unsaturated group-containing monomers (A); at least one kind of hydrophilic substance (B) in an amount of more than 0% by weight but not more than 20% by weight relative to the total amount of the ethylenically unsaturated group-containing monomers (A), being selected from a group consisting of a surfactant, a plasticizer and a moisturizer; polyvinyl alcohol (C) in an amount of more than 0% by weight but not more than 30% by weight relative to a total amount of the ethylenically unsaturated group-containing monomers (A), having a degree of saponification of more than 82 mol %; and water.

In addition, according to the present invention, there is provided a sustained release preparation comprising the water dispersion and a volatile active substance selected from a group consisting of a pheromone substance, an agricultural chemical, an aromatic, a deodorant and an antibacterial agent.

Furthermore, according to the present invention, there is provided a method for producing a water dispersion for a sustained release preparation, comprising a polymerization step of emulsion-polymerizing ethylenically unsaturated group-containing monomers (A) in the presence of a hydrophilic substance (B) and/or polyvinyl alcohol (C) to obtain a polymer particle water dispersion having viscosity at 25° C. of not more than 100 mPa·s, wherein the polyvinyl alcohol (C) is selected from a group consisting of polyvinyl alcohol (C1) having a degree of saponification of more than 82 mol % but not more than 91.5 mol %, polyvinyl alcohol (C2) having a degree of saponification of more than 91.5 mol % but less than 98 mol %, and polyvinyl alcohol (C3) having a degree of saponification of not less than 98 mol %, and wherein both of the hydrophilic substance (B) and the polyvinyl alcohol (C) are present during the polymerization, or one of the hydrophilic substance (B) and the polyvinyl alcohol (C) is present during the polymerization and the other of the hydrophilic substance (B) and the polyvinyl alcohol (C), which is not present during the polymerization, is blended after the polymerization, or the polyvinyl alcohol (C) and one portion of the hydrophilic substance (B) are present during the polymerization and the other portion of the hydrophilic substance (B) is blended after the polymerization, so that the hydrophilic substance (B) is in an amount of more than 0% by weight but not more than 20% by weight relative to the total amount of the ethylenically unsaturated group-containing monomers (A) and the polyvinyl alcohol (C) is in an amount of more than 0% by weight but not more than 30% by weight relative to a total amount of the ethylenically unsaturated group-containing monomers (A).

According to the present invention, provided is a water dispersion type sustained release preparation for releasing a volatile active substance at a constant rate over a long period of time until substantially all the content of which can be released and which has low viscosity and a sufficient adhesion property.

### BRIEF DESCRIPTION OF DRAWINGS

FIG. 1 is a graph exhibiting a relationship between remaining amounts of pheromone and elapsed days in Examples 1 to 15 and Comparative Examples 1 to 5.

FIG. 2 is a graph exhibiting a relationship between remaining amounts of pheromone and elapsed days in Examples 16 to 33 and Comparative Examples 6 to 9.

FIG. 3 is a graph exhibiting a relationship between remaining amounts of pheromone and elapsed days in Examples 34 to 43 and Comparative Examples 10 to 15.

FIG. 4 is a graph exhibiting a relationship between remaining amounts of pheromone and elapsed days in Examples 44, 46, 48, 50, and 56.

FIG. 5 is a graph exhibiting a relationship between remaining amounts of pheromone and elapsed days in Examples 61 to 66.

FIG. 6 is a graph exhibiting a relationship between remaining amounts of pheromone and elapsed days in Examples 67 to 71.

FIG. 7 is a graph exhibiting a relationship between remaining amounts of pheromone and elapsed days in Examples 72 to 77.

FIG. 8 is a graph exhibiting a relationship between remaining amounts of pheromone and elapsed days in Examples 78 to 82.

FIG. 9 is a graph exhibiting a relationship between remaining amounts of pheromone and elapsed days in Examples 83 to 88.

FIG. 10 is a graph exhibiting a relationship between remaining amounts of pheromone and elapsed days in Examples 89 to 93.

### DESCRIPTION OF THE EMBODIMENTS OF THE INVENTION

The present invention now will be described more fully hereinafter in which embodiments of the invention are provided with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. Unless otherwise defined, all technical and scientific terms used herein have the same meaning as commonly understood by one of ordinary skill in the art to which this invention belongs. All references cited are incorporated herein by reference in their entirety.

It should also be understood that many modifications and variations of the described embodiments of the invention will occur to a person having an ordinary skill in the art without departing from the spirit and scope of the present invention as claimed in the appended claims.

Examples of the ethylenically unsaturated group-containing monomers (A) to be used in the present invention include olefin hydrocarbon monomers such as ethylene and propylene; vinyl carboxylate monomers such as vinyl acetate and vinyl propionate; chlorine-containing ethylene monomers such as vinyl chloride and vinylidene chloride; aromatic vinyl monomers such as styrene and α-methylstyrene; conjugated diene monomers such as 1,3-butadiene and 2-methyl-1,3-butadiene; ethylenically unsaturated monocarboxylate ester monomers such as methyl acrylate, ethyl acrylate, butyl acrylate, 2-ethylhexyl acrylate and methyl methacrylate; ethylenically unsaturated dicarboxylate ester monomers such as dimethyl itaconate, diethyl maleate, monobutyl maleate, monoethyl fumarate and dibutyl fumarate; ethylenically unsaturated monocarboxylic acid monomers such as acrylic acid, methacrylic acid and crotonic acid; and ethylenically unsaturated dicarboxylic acid monomers such as itaconic acid, maleic acid and fumaric acid; epoxy group-containing ethylenically unsaturated monocarboxylate ester monomers such as glycidyl methacrylate; alcohol group-containing ethylenically unsaturated monocarboxylate ester monomers such as 2-hydroxyethyl methacrylate; alkoxyl group-containing ethylenically unsaturated monocarboxylate ester monomers such as methoxyethyl acrylate; nitrile group-containing ethylene monomers such as acrylonitrile; amide group-containing ethylene monomers such as acrylamide; amino group-containing ethylenically unsaturated monocarboxylate ester monomers such as dimethylaminoethyl methacrylate; and monomers containing two or more ethylenically unsaturated groups in one molecule such as divinylbenzene and allyl methacrylate. The vinyl carboxylate monomers and ethylenically unsaturated monocarboxylate ester are preferable.

The number of carbon atoms in the ethylenically unsaturated group-containing monomers (A) preferably ranges from 2 to 13 including the number of carbon atoms in the functional group.

In addition, a glass-transition temperature T of the polymer particles obtained by polymerizing the ethylenically unsaturated group-containing monomers (A) (hereinafter, the glass-transition temperature may be referred to as Tg) is preferably not more than 30° C., more preferably from −50° C. to 30° C. in consideration of a point that the applied sustained release preparation is adhered to leaves and does not fall to the ground. The monomer is selected using the following equation.

(Pa+Pb+Pc)/T=(Pa/Ta)+(Pb/Tb)+(Pc/Tc) (1)

In Equation (1), T represents a glass-transition temperature (K) of the polymer particles, Pa, Pb and Pc represent contents (% by weight) of the monomers a, b and c, respectively, and Ta, Tb, and Tc represent homopolymer glass-transition temperatures (K) of the monomer a, b, and c, respectively.

The glass-transition temperature can be measured based on JIS K 7121.

According to the present invention, at least one kind of polyvinyl alcohol (hereinafter, referred to as “PVA” in some cases) and a hydrophilic substance are present in a system. The ethylenically unsaturated group-containing monomers (A) may be polymerized in the presence of PVA and the hydrophilic substance (e.g. surfactant), or polymerized in the presence of PVA and then subjected to an addition of the hydrophilic substance to the obtained polymer particle water dispersion, or polymerized in the presence of the hydrophilic substance (e.g. surfactant) and then subjected to an addition of PVA to the obtained polymer particle water dispersion. Alternatively, the ethylenically unsaturated group-containing monomers (A) are polymerized in the presence of a part of PVA, a part of the hydrophilic substance, or a part of a combination of PVA and the hydrophilic substance, and then subjected to an addition of the remainder (for supplying a shortage) to the obtained polymer particle water dispersion, so as to obtain a desired amount of PVA and a desired amount of hydrophilic substance.

In a preferable embodiment, the hydrophilic substance (B) in an amount of more than 0% by weight but not more than 20% by weight relative to the total amount of the ethylenically unsaturated group-containing monomers (A) and the polyvinyl alcohol (C) in an amount of more than 0% by weight but not more than 30% by weight relative to the total amount of the ethylenically unsaturated group-containing monomers (A) can be present during the polymerization without the blending after the polymerization.

In another preferable embodiment, the hydrophilic substance (B) can be present during the polymerization and the polyvinyl alcohol (C) can be blended after the polymerization, or the polyvinyl alcohol (C) can be present during the polymerization and the hydrophilic substance (B) can be blended after the polymerization, so that the hydrophilic substance (B) is in an amount of more than 0% by weight but not more than 20% by weight and the polyvinyl alcohol (C) is in an amount of more than 0% by weight but not more than 30% by weight relative to the total amount of the ethylenically unsaturated group-containing monomers (A).

In a still another preferable embodiment, the polyvinyl alcohol (C) and one part of the hydrophilic substance (B) can be present during the polymerization and the other part of the hydrophilic substance (B) can be blended after the polymerization, so that the hydrophilic substance (B) is in an amount of more than 0% by weight but not more than 20% by weight and the polyvinyl alcohol (C) is in an amount of more than 0% by weight but not more than 30% by weight relative to the total amount of the ethylenically unsaturated group-containing monomers (A). The hydrophilic substance (B) is present during the polymerization preferably in an amount of 0.5 to 10% by weight relative to the total amount of the ethylenically unsaturated group-containing monomers (A) and the remainder of the hydrophilic substance (B) is blended after the polymerization so that the hydrophilic substance (B) is in an amount of not more than 30% by weight relative to the total amount of the ethylenically unsaturated group-containing monomers (A). At this time, surfactant is preferably used as the hydrophilic substance (B).

The degree of saponification of PVA to be used in the present invention is preferably more than 82 mol %. When the degree of saponification is not more than 82 mol %, the amount of remaining acetate in PVA is large so that compatibility with the volatile active substance becomes higher. As a result, there may be defect that a desired release rate cannot be achieved, or defect that some of the volatile active substance is not released and is wasted. In addition, although a degree of polymerization of PVA is not particularly limited, an aqueous solution of PVA having a high degree of polymerization may have high viscosity and it may become necessary to reduce an evaporation residue in order to obtain proper viscosity of the polymer particle water dispersion. In order to reduce the evaporation residue, the volatile active substance for impregnation is decreased. Accordingly, an average degree of polymerization calculated based on JIS K 6726 is preferably from 400 to 2000, more preferably from 500 to 1700.

In the present invention, since it is considered that the polymer part inside the emulsion particle is more hydrophobic than an external dispersant so that it is considered that the inside of the emulsion particle is impregnated with the hydrophobic volatile active substance.

The hydrophilic substance (B) is selected from a group consisting of a surfactant, a plasticizer and a moisturizer. Specifically, the hydrophilic substance (B) is preferably selected from a substance having at least one functional group or structure selected from a group consisting of a sulfate group, a sulfone group, a phosphate group, a carboxyl group, an amino group, a quaternary ammonium salt, an ethylene oxide chain, a hydroxyl group, alkyne, urea and amide, and having a molecular weight of from 50 to 5000.

Examples of the surfactant include the following surfactants (1) to (4), and one or more kinds of these surfactants are preferably used.

(1) An anionic surfactant such as alkyl sulfate ester salt, polyoxyethylene alkyl ether sulfate ester salt, alkylbenzene sulfonate salt, alkyl diphenylether sulfonate salt, alkyl naphthalene sulfonate salt, fatty acid salt, dialkylsulfosuccinate salt, alkyl phosphate ester salt and polyoxyethylene alkylphenyl phosphate ester salt.

(2) A non-ionic surfactant such as polyoxyethylene alkyl phenyl ether, polyoxyethylene alkyl ether, polyoxyethylene fatty acid ester, sorbitan fatty acid ester, polyoxyethylene sorbitan fatty acid ester, polyoxyalkylene alkyl ether, polyoxyethylene derivative, glycerin fatty acid ester, polyoxyethylene hydrogenated castor oil, polyoxyethylene alkylamine, alkyl alkanolamide, or acetylene alcohol, acetylene glycol, and ethylene oxide adducts thereof.

(3) A cationic surfactant such as alkyl trimethyl ammonium chloride, dialkyl dimethyl ammonium chloride, alkyl benzyl ammonium chloride and alkylamine salt.

(4) A polymerizable surfactant having a double bond with a radical polymerization ability in a molecule, such as alkyl allyl sulfosuccinate salt, methacryloyl polyoxyalkylene sulfate ester salt and polyoxyethylene nonyl propenyl phenyl ether sulfate ester salt.

A group of the plasticizer and the moisturizer is preferably a group of plasticizer and moisturizer used in PVA. Examples thereof include a low-molecular water-soluble substance such as glycerin, ethylene glycol, trimethylene glycol, tetramethylene glycol, pentamethylene glycol, hexamethylene glycol, propylene glycol, 2,3-butanediol, 1,3-butanediol, diethylene glycol, triethylene glycol and urea; a high-molecular water-soluble substance of synthetic high-molecular electrolyte such as polyacrylic acid and salt thereof, polymethacrylic acid and salt thereof, polyacrylamide and partially saponified substances of polyacrylic acid ester; hydroxyalkyl cellulose such as hydroxymethyl cellulose, hydroxyethyl cellulose and carboxymethyl cellulose; alkyl cellulose such as methyl cellulose; and a water-soluble cellulose derivative such as starch.

The hydrophilic substance (B) can be added to the polymer particle water dispersion obtained by polymerizing the ethylenically unsaturated group-containing monomers (A) as described above. Alternatively, if the hydrophilic substance (B) is a surfactant, it can be present in the polymerization of the ethylenically unsaturated group-containing monomers (A). When PVA and/or the surfactant is present in the polymerization, the amount of the hydrophilic substance (B) is preferably more than 0% by weight but not more than 30% by weight, more preferably from 0.5 to 25% by weight relative to the ethylenically unsaturated group-containing monomers (A), if only PVA or both PVA and the surfactant are present in the polymerization. The amount of the hydrophilic substance (B) is preferably more than 0% by weight but not more than 20% by weight, more preferably from 0.5% by weight to 10% by weight, if only the surfactant is present in the polymerization.

Examples of the polymerization initiator for the polymerization of the ethylenically unsaturated group-containing monomers to be used in the present invention include persulfate salts such as sodium persulfate, ammonium persulfate and potassium persulfate; azo compounds such as 2,2′-diamidino-2,2′-azopropane dihydrochloride salt and azobisisobutyronitrile; peroxide such as cumene hydroperoxide, benzoyl peroxide and hydrogen peroxide. In addition, a known redox initiator such as potassium persulfate and sodium hydrogen sulfite can also be included. The amount of the polymerization initiator is typically from 0.05 to 10% by weight, preferably from 0.1 to 2% by weight relative to the total amount of the monomers.

According to the present invention, the temperature at which the polymer particle water dispersion is produced is generally 30° C. to 95° C., preferably 60° C. to 80° C., and the polymerization time is generally 3 to 20 hours, preferably 4 to 8 hours. The polymerization is carried out preferably in an atmosphere of inert gas such as nitrogen gas.

The weight-average molecular weight of the polymer produced by polymerization of the ethylenically unsaturated group-containing monomers (A) is preferably from 100,000 to 1 million, more preferably from 100,000 to 800,000 in terms of polystyrene measured by using gel permeation chromatography (GPC).

The solid content of the polymer particle water dispersion is preferably from about 30 to 65% by weight.

In addition, an ethylenically unsaturated group-containing monomer having a functional group can be comprised in an amount which does not compromise the effect of the present invention. Such examples include epoxy group-containing monomers such as glycidyl methacrylate; methylol group-containing monomers such as N-methylolacrylamide; alcoholic hydroxyl group-containing monomers such as 2-hydroxyethyl methacrylate; alkoxyl group-containing monomers such as methoxyethyl acrylate; nitrile group-containing monomers such as acrylonitrile; amide group-containing monomers such as acrylamide; amino group-containing monomers such as dimethylaminoethyl methacrylate; and monomers having two or more ethylenically unsaturated groups in one molecule such as divinylbenzene and allyl methacrylate.

As for the polymerization in the present invention, any known polymerization methods such as emulsion-polymerization method can be employed. The monomer and a polymerization aid may be added all at once in an initial stage, or may be continuously added, or one part of the monomer and the polymerization aid may be added in an initial stage and the other part thereof may be continuously or dividedly added during the polymerization. The polymerization aid includes an emulsifier such as alkyl sulfuric acid ester salt, a polymerization initiator such as ammonium persulfate, a chain transfer agent such as mercaptans, a pH adjuster such as sodium carbonate, and various kinds of defoaming agent.

According to the present invention, the water dispersion type sustained release preparation comprises a polymer particle water dispersion having viscosity of not more than 100 mPa·s, which is obtained by polymerizing the ethylenically unsaturated group-containing monomers (A) and which comprises the hydrophilic substance (B) and the polyvinyl alcohol (C) having a degree of saponification of more than 82 mol %.

According to the present invention, in a first preferable embodiment of the water dispersion type sustained release preparation, a water dispersion type sustained release preparation comprises a polymer particle water dispersion which is obtained by polymerizing the ethylenically unsaturated group-containing monomers (A) and which comprises the hydrophilic substance (B) and polyvinyl alcohol (C1) having a degree of saponification of more than 82 mol % but not more than 91.5 mol %.

The hydrophilic substance (B) is used in an amount of more than 0% by weight but not more than 20% by weight, preferably from 4 to 15% by weight relative to the total amount of the ethylenically unsaturated group-containing monomers (A). When the amount exceeds 20% by weight, there is defect that the polymer particle water dispersion becomes hydrophilic and after the polymer particle water dispersion is applied to a target and changed to a dried film, the film is re-emulsified by a small amount of rain or the like and the volatile active substance falls off along with the polymer particles.

The polyvinyl alcohol (C1) having a degree of saponification of more than 82 mol % but not more than 91.5 mol % is used in an amount of more than 0% by weight but not more than 30% by weight, preferably from 5 to 25% by weight relative to the total amount of the ethylenically unsaturated group-containing monomers (A). When the amount exceeds 30% by weight, there is defect that the polymer particle water dispersion becomes hydrophilic and after the polymer particle water dispersion is applied to a target and changed to a dried film, the film is re-emulsified by a small amount of rain or the like and the volatile active substance falls off along with the polymer particles.

According to the present invention, in a second preferable embodiment of the water dispersion type sustained release preparation, a water dispersion type sustained release preparation comprises a polymer particle water dispersion which is obtained by polymerizing the ethylenically unsaturated group-containing monomers (A) and which comprises the hydrophilic substance (B) and polyvinyl alcohol (C2) having a degree of saponification of more than 91.5 mol % and less than 98.0 mol %.

The hydrophilic substance (B) is used in an amount of more than 0% by weight but not more than 20% by weight, preferably from 4 to 15% by weight relative to the total amount of the ethylenically unsaturated group-containing monomers (A). When the amount exceeds 20% by weight, there is defect that the polymer particle water dispersion becomes hydrophilic and after the polymer particle water dispersion is applied to a target and changed to a dried film, the film is re-emulsified by a small amount of rain or the like and the volatile active substance falls off along with the polymer particles.

The polyvinyl alcohol (C2) having a degree of saponification of more than 91.5 mol % and less than 98 mol % is used in an amount of more than 0% by weight but not more than 30% by weight, preferably from 5 to 25% by weight relative to the total amount of the ethylenically unsaturated group-containing monomers (A). When the amount exceeds 30% by weight, there is defect that the polymer particle water dispersion becomes hydrophilic and after the polymer particle water dispersion is applied to a target and changed to a dried film, the film is re-emulsified by a small amount of rain or the like and the volatile active substance falls off along with the polymer particles.

According to the present invention, in a third preferable embodiment of the water dispersion type sustained release preparation, a water dispersion type sustained release preparation comprises a polymer particle water dispersion which is obtained by polymerizing the ethylenically unsaturated group-containing monomers (A) and which comprises the hydrophilic substance (B) and polyvinyl alcohol (C3) having a degree of saponification of not less than 98 mol %.

The hydrophilic substance (B) is used in an amount of more than 0% by weight but not more than 20% by weight, preferably from 4 to 15% by weight relative to the total amount of the ethylenically unsaturated group-containing monomers (A). When the amount exceeds 20% by weight, there is defect that the polymer particle water dispersion becomes hydrophilic and after the polymer particle water dispersion is applied to a target and changed to a dried film, the film is re-emulsified by a small amount of rain or the like and the volatile active substance falls off along with the polymer particles.

The polyvinyl alcohol (C3) having a degree of saponification of not less than 98 mol % is used in an amount of more than 0% by weight but not more than 30% by weight, preferably from 5 to 25% by weight relative to the total amount of the ethylenically unsaturated group-containing monomers (A). When the amount exceeds 30% by weight, there is defect that the polymer particle water dispersion becomes hydrophilic and after the polymer particle water dispersion is applied to a target and changed to a dried film, the film is re-emulsified by a small amount of rain or the like and the volatile active substance falls off along with the polymer particles.

In addition, PVA having a special functional group such as anion-modified PVA, cation-modified PVA and terminally SH-modified PVA can also be used.

A molar ratio of hydrophilic part to acetate part will be explained below.

When x parts by weight of polyvinyl alcohol having a degree of saponification of 100α mol % and y parts by weight of a hydrophilic substance having a molecular weight β are used, the following equations are obtained, provided that the molecular weight of the vinyl alcohol is 44, and the molecular weight of the vinyl acetate is 86.

Molar amount of hydrophilic part

=[x×44α/{44α+86(1−α)}]/44+y/β (2)

Molar amount of acetate part

=x×86(1−α)/{44α+86×(1−α)}/86 (3)

The molar ratio of hydrophilic part to acetate part is calculated by dividing a value obtained in equation (2) by a value obtained in equation (3).

The molar ratio of hydrophilic part to acetate part is a ratio of a molar amount of the hydrophilic part which is a total molar amount of vinyl alcohol monomer units in the vinyl alcohol (C) and the hydrophilic substance (B) to a molar amount of the acetate part which is a total molar amount of vinyl acetate monomer units in the polyvinyl alcohol (C) with respect to the total amount of the polyvinyl alcohol (C) and the hydrophilic substance (B). It is preferably not more than 15.0 when the polyvinyl alcohol (C) is the polyvinyl alcohol (C1). It is preferably not more than 40.0 when the polyvinyl alcohol (C) is the polyvinyl alcohol (C2). It is preferably not more than 90.0 when the polyvinyl alcohol (C) is the polyvinyl alcohol (C3).

According to the present invention, in a first preferable embodiment of the water dispersion type sustained release preparation, the molar ratio of hydrophilic part to acetate part (the molar ratio of hydrophilic part/acetate part) with respect to the total amount of the hydrophilic substance (B) and the partially saponified polyvinyl alcohol (C1) is preferably not more than 15.0, more preferably from 7.0 to 15.0. When the ratio exceeds 15.0, there may be defect that the release rate of the volatile active substance becomes excessively high.

According to the present invention, in a second preferable embodiment of the water dispersion type sustained release preparation, the molar ratio of hydrophilic part to acetate part (the molar ratio of hydrophilic part/acetate part) with respect to the total amount of the hydrophilic substance (B) and the intermediately saponified polyvinyl alcohol (C2) is preferably not more than 40.0, more preferably from 15.5 to 40.0. When the ratio exceeds 40, there may be defect that the release rate of the volatile active substance becomes excessively high.

According to the present invention, in a third preferable embodiment of the water dispersion type sustained release preparation, the molar ratio of hydrophilic part to acetate part (the molar ratio of hydrophilic part/acetate part) with respect to the total amount of the hydrophilic substance (B) and the fully saponified polyvinyl alcohol (C3) is preferably not more than 90.0, more preferably from 50.0 to 90.0. When the ratio exceeds 90.0, there may be defect that the release rate of the volatile active substance becomes excessively high.

When w represents the aforementioned molar amount of hydrophilic part, a value of (y/β)/w is preferably not more than 0.4, more preferably not more than 0.36, further more preferably from 0.001 to 0.36. When the value exceeds 0.4, there is defect that it becomes difficult to control the release rate of the volatile active substance.

The volatile active substance to be used in the present invention is not particularly limited. Preferable examples thereof include a pheromone substance, an agricultural chemical, an aromatic, a deodorant and an antibacterial agent. When the compatibility between a volatile active substance and PVA becomes excessively high, the volatile active substance may be unreleased and remain. Accordingly, a volatile active substance is preferably selected from a group consisting of acetate, alcohol (including phenol), epoxide, alkane, alkene, aldehyde, ketone, carboxylic acid, ester and ether, each having a boiling point (normal boiling point at 1 atm) of from 100° C. to 350° C. and having 6 to 20 carbon atoms. It is further preferable to select a compound having a boiling point of from 200° C. to 350° C. with respect to a pheromone substance and a compound having a boiling point of from 100° C. to 320° C. with respect to the volatile active substances other than the pheromone substance.

Examples of the pheromone substance for fruit tree pests include Z-8-dodecenyl acetate as sex pheromone of Oriental Fruit Moth (OFM), E,E-8,10-dodecadienol as sex pheromone of Codling Moth (CDM), and E-5-decenyl acetate as sex pheromone of Peach Twig Borer (PTwB). Examples of pheromone substance for forest pests include (±)-cis-7,8-epoxy-2-methyloctadecane as sex pheromone of Gypsy Moth (GM). Examples of sex pheromone for cotton pests include ZZ/ZE-7,11-hexadecadienyl acetate as sex pheromone of Pink Bollworm (PBW).

Examples of the agricultural chemical include an agricultural chemical having a relatively high vapor pressure such as diazinon and propylene glycol fatty acid monoester.

Examples of the aromatic include natural essential oils such as orange oil, lemon oil and lemongrass oil; hydrocarbon terpenes such as α-pinene, β-pinene and limonene; aldehydes such as heptanal, octanal and citral; ester such as ethyl formate and methyl acetate; lactonic acid; ethers such as anisole and p-cresyl methyl ether; alcohols such as trans-2-hexenol and leaf alcohol; ketones such as menthone and acetophenone.

Examples of the deodorant include a botanical extract type deodorant such as lauryl methacrylate and polyphenol; and a reactive type deodorant such as betaine compound.

Examples of the antibacterial agent include aldehydes such as phenylpropionic aldehyde and citral; and alcohols such as linalool and citronellol.

The amount of the volatile active substance comprised by the water dispersion type sustained release preparation (content before use, or initial content) is preferably from 3 to 20% by weight, more preferably from 5 to 10% by weight relative to the total amount of the ethylenically unsaturated group-containing monomers (A). When the amount is less than 3% by weight, the release rate may become extremely low. When the amount is more than 20% by weight, the release rate may become excessively high. The amount of the volatile active substance desirably reaches less than 5% by weight at the end of use, provided that the initial amount (the amount when the release is started) is 100% by weight. As for the pheromone substance, the remaining amount of the volatile active substance preferably becomes 60 to 75% by weight after 10 days, not more than 35% by weight after 60 days, and less than 5% by weight after 70 days to 120 days, provided that the initial amount is 100% by weight. As for the volatile active substance other than the pheromone substance, the remaining amount of the volatile active substance preferably becomes 60 to 80% by weight after 20 days, not more than 35% by weight after 90 days, and less than 5% by weight after 120 days to 250 days, provided that the initial amount is 100% by weight.

Most types of volatile active substances are lipophilic and not dissolved in water. When the volatile active substance is mixed with polymer particle water dispersion, the polymer particle water dispersion is impregnated with the volatile active substance.

The volatile active substance is added after the polymerization of the ethylenically unsaturated group-containing monomers (A).

The water dispersion type sustained release preparation is obtained by mixing the polymer particle water dispersion and the volatile active substance by using a known mixing preparation method such as use of a propeller type stirrer. The temperature for mixing may be a temperature at which the volatile active substance is not evaporated. It is preferably from 10 to 30° C. The stirring time is preferably from 5 minutes to 2 hours.

The time at which the volatile active substance is mixed may be after the polymerization step or before blending the polyvinyl alcohol after the polymerization.

The viscosity of the sustained release preparation is preferably not more than 100 mPa·s, further preferably from 30 to 100 mPa·s. Since the addition of the volatile active substance has substantially no influence on the viscosity of the sustained release preparation, the viscosity of the polymer particle water dispersion is preferably not more than 100 mPa·s, further preferably from 30 to 100 mPa·s. When the viscosity exceeds 100 mPa·s, the particle size during the spray increases, which may not be preferable. The viscosity at 25° C. can be measured by using a B-type viscosity meter.

The sustained release preparation can be sprayed, for example, through an aerial spray from an aircraft or a helicopter, or through a ground spray from a vehicle such as a tractor. It is also possible to utilize a conventional method in which a container filled with the sustained release preparation is installed. The sustained release preparation can be sprayed at a constant amount, for example, through a spray or an atomizing nozzle.

In addition, it is also possible to use a base material such as cotton cloth, wood, paper and plastic, which has been coated or impregnated with the sustained release preparation.

The spray amount of the volatile active substance is preferably from 50 to 3000 g/acre. The sprayed or applied sustained release preparation is formed, through air drying or heat drying, into a membrane, a film or a particle preferably having a thickness of from 0.5 to 500 μm, more preferably 1 to 100 μm, although depending on a sprayed or applied amount. Then the volatile active substance is released at a constant rate.

Hereinafter, the present invention will be explained based on Examples and Comparative Examples. However, it should not be construed that the present invention is limited to Examples.

### EXAMPLES

### Example 1

The 100 parts by weight of ion-exchanged water was placed in a four-necked glass flask equipped with a stirrer, a reflux condenser and a thermometer, and air displacement with nitrogen was sufficiently performed in the flask. Then stirring was started. The temperature inside the flask was raised to 75° C., and 0.5 parts by weight of sodium persulfate was added thereto as a polymerization initiator. The 100 parts by weight of vinyl acetate monomers, 30 parts by weight of aqueous 20 wt % (% by weight) solution of PVA (JP-05 produced by Japan VAM & POVAL Co., Ltd., a degree of saponification of 88 mol %, an average polymerization degree of 500), which was 6% by weight relative to the vinyl acetate monomers, and 36 parts by weight of ion-exchanged water were placed and stirred in a homo-mixer for 5 minutes to prepare a emulsion of monomers. After the emulsion was added dropwise into the four-necked flask for four hours, the polymerization was further continued for 2 hours. Then, the resulting mixture was reacted at 80° C. for 1 hour and cooled to 30° C. A polyvinyl acetate particle water dispersion having 40% by weight of evaporation residue and viscosity of 50 mPa·s was obtained.

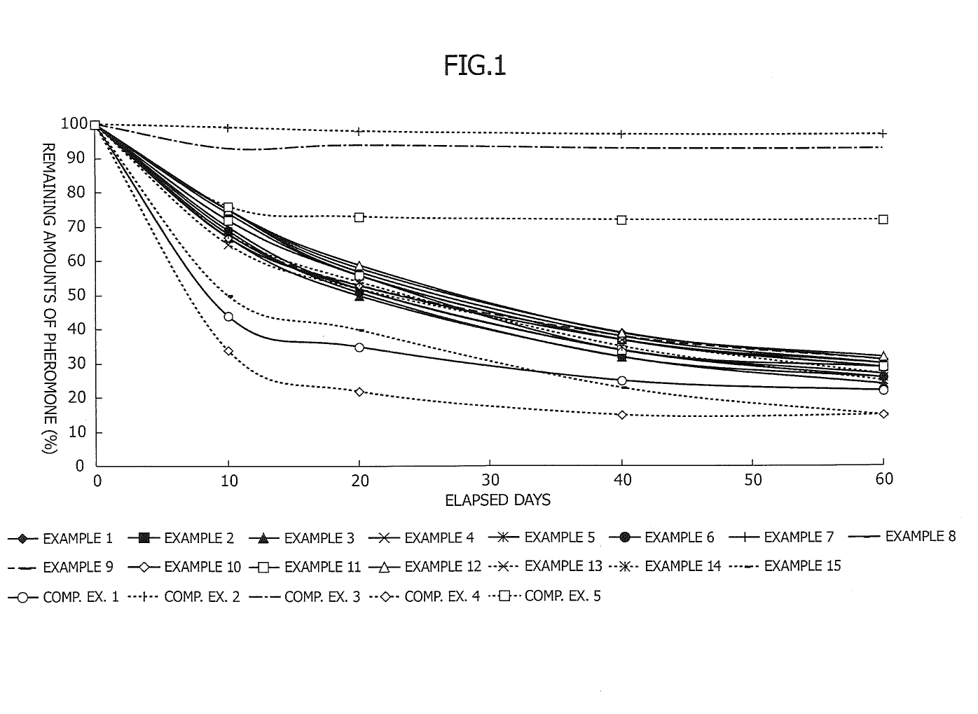

To the water dispersion, 5 parts by weight of Z-8-dodecenyl acetate (product of Shin-Etsu Chemical Co., Ltd., boiling point of 300° C.) as sex pheromone of OFM was added. The mixture was stirred at 25° C. for 1 hour. Thereafter, 10 parts by weight of aqueous 80 wt % solution of surfactant (non-ionic surfactant NOIGEN XL-160 produced by Dai-ichi Kogyo Seiyaku Co., Ltd, polyoxyalkylene branched decyl ether, molecular weight of 862), which was 8% by weight relative to the vinyl acetate monomers, was added thereto. The mixture was further stirred at 25° C. for 30 minutes to produce a sustained release preparation. Then, the molar ratio of hydrophilic part/acetate part was calculated in the manner shown below, the evaporation residue and the viscosity of the polymer particle water dispersion were measured, and a weather resistant test and a volatile active substance release test of the sustained release preparation were conducted. The composition in each step is shown in Table 1, and the results are shown in Table 2 and FIG. 1.

### <Calculation of a Molar Ratio of Hydrophilic Part to Acetate Part>

$$\begin{matrix}Molar amount of hydrophilic part = [ 6 \times ( 44 \times 0.88 ) / \{ 44 \times 0.88 + 86 ( 1 - 0.88 ) \} ] / 44 + 8 / 862 \\ = 0.1169\end{matrix}$$

$$\begin{matrix}Molar amount of acetate part = 6 \times 86 \times ( 1 - 0.88 ) / \{ 44 \times 0.88 + 86 \times ( 1 - 0.88 ) \} / 86 \\ = 0.0147\end{matrix}$$

$$\begin{matrix}Molar ratio of hydrophilic part to acetate part = 0.1169 / 0.0147 \\ = 8.0\end{matrix}$$

### <Evaporation Residue>

A sample of about 1 g of the polymer particle water dispersion was precisely measured and placed on a dish made of aluminum foil. The sample on the dish was placed in a drier which had been maintained at about 105° C., and heated for one hour. It was taken out from the drier, and cooled in a desiccator. The weight of the sample after the drying was measured, and the evaporation residue was calculated by the following equation.

$$R = \frac{T - L}{W - L} \times 100$$

R: evaporation residue (% by weight)
W: weight of aluminum foil dish with sample thereon before drying (g)
L: weight of aluminum foil dish (g)
T: weight of aluminum foil dish with sample thereon after drying (g)
Dimension of aluminum foil dish: 70φ×height 12 (mm)

<Viscosity Measuring Method by B-Type Viscosity Meter>

The liquid temperature of the polymer particle water dispersion was maintained at 25±1.0° C., and the viscosity was measured by a BM type viscosity meter (60 rpm).

### <Glass-Transition Temperature of Polymer>

The glass-transition temperature was measured based on JIS K 7121.

### <Weather Resistance>

Twelve dots of 2 μl of the obtained water dispersion type sustained release preparation containing the volatile active substance were marked on a glass plate and dried in a dryer at 25° C. for one day. The number of dots which fell off during watering from a watering pot for 10 minutes was checked.

High: all the twelve dots were held.
Low: falling off of at least one dots among the twelve dots was observed.

### <Volatile Active Substance Release Test>

The 2 μl dot of the obtained water dispersion type sustained release preparation containing the volatile active substance was applied to a film made of polyethylene terephthalate, dried in a constant temperature and constant moisture room at 23° C. and 45% RH for 16 hours, to obtain the dried sustained release preparation containing volatile active substance.

Next, the preparation was installed in a dryer with a wind velocity of 0.7 m/second, and changes in weight were measured as a release rate of the volatile active substance from the preparation. In addition, the temperature in the dryer was set to 25° C. when the sustained release preparations contained sex pheromone of OFM, or CDM or PTwB which will be described later. The temperature in the dryer was set to 30° C. when the sustained release preparation contained sex pheromone of GM or PBW, which will be described later, or the other kind of volatile active substance.

As the release amount of the volatile active substance, the remaining amounts of the volatile active substance on 10th day, 20th day, 30th day and 40th day, or 20th day, 40th day, 60th day and 90th day are shown by a weight ratio relative to the initial amount (the amount when the release was started) of 100. In addition, the days when the remaining amount of the volatile active substance reached not more than 5% (weight ratio of not more than 5) were shown in Tables.

### Examples 2 to 10 and 12 to 15 and Comparative Examples 1 to 5

The polymer particle water dispersion and the sustained release preparation were produced based on the polymerization compositions with an addition after the polymerization as shown in Table 1 in the same manner as in Example 1. Then the same tests as those in Example 1 were conducted. The used PVA included JP-05 (product of Japan VAM & POVAL Co., Ltd., a degree of saponification of 88 mol %, an average polymerization degree of 500), PVA-706 (product of Kuraray Co., Ltd., a degree of saponification of 91.5 mol %, an average polymerization degree of 600), and JL-05E (product of Japan VAM & POVAL Co., Ltd., a degree of saponification of 82 mol %, an average polymerization degree of 500). The used sex pheromone included Z-8-dodecenyl acetate (product of Shin-Etsu Chemical Co., Ltd., boiling point of 300° C.) as sex pheromone of OFM, E,E-8,10-dodecadienol (product of Shin-Etsu Chemical Co., Ltd., boiling point of 271° C.) as sex pheromone of CDM, (±)-cis-7,8-epoxy-2-methyloctadecane (product of Shin-Etsu Chemical Co., Ltd., boiling point of 332° C.) as sex pheromone of GM, E-5-dodecenyl acetate (product of Shin-Etsu Chemical Co., Ltd., boiling point of 211° C.) as sex pheromone of PTwB, and ZZ/ZE-7,11-hexadecadienyl acetate (product of Shin-Etsu Chemical Co., Ltd., boiling point of 349° C.) as sex pheromone of PBW. The used hydrophilic substance included NOIGEN XL-60 (non-ionic surfactant produced by Dai-ichi Kogyo Seiyaku Co., Ltd., polyoxyalkylene branched decyl ether, molecular weight of 422), NOIGEN XL-160 (non-ionic surfactant produced by Dai-ichi Kogyo Seiyaku Co., Ltd, molecular weight of 862), PERSOFT EL (anionic surfactant produced by NOF Corporation, polyoxyethylene-alkyl ether-sodium sulfate, molecular weight of 420), and glycerin (molecular weight of 92). The results are shown in Table 2 and FIG. 1.

### Example 11

The 100 parts by weight of ion-exchanged water was placed in a four-necked glass flask equipped with a stirrer, a reflux condenser and a thermometer, and air displacement with nitrogen was sufficiently performed in the flask. Then stirring was started. The temperature inside the flask was raised to 75° C., and 0.5 parts by weight of sodium persulfate was added thereto as a polymerization initiator.

The 100 parts by weight of vinyl acetate monomers, 30 parts by weight of aqueous 20 wt % (% by weight) solution of PVA (JP-05 produced by Japan VAM & POVAL Co., Ltd., a degree of saponification of 88 mol %, an average polymerization degree of 500), which was 6% by weight relative to the vinyl acetate monomers, 10 parts by weight of an aqueous 80 wt % solution of surfactant (non-ionic surfactant NOIGEN XL-160 produced by Dai-ichi Kogyo Seiyaku Co., Ltd, molecular weight of 862), which was 8% by weight relative to the vinyl acetate monomer, and 36 parts by weight of ion-exchanged water were placed and stirred in a homo-mixer for 5 minutes to prepare a emulsion of monomers. After the emulsion was added dropwise into the four-necked flask for 4 hours, the polymerization was further continued for 2 hours. Then, the resulting mixture was reacted at 80° C. for 1 hour and cooled to 30° C. A polyvinyl acetate particle water dispersion having 41.4% by weight of evaporation residue and viscosity of 70 mPa·s was obtained.

Thereafter, a sustained release preparation was produced in the same manner as in Example 1, and the same tests as those in Example 1 were conducted. The composition in each step is shown in Table 1, and the results are shown in Table 2 and FIG. 1.

TABLE 1

| | polymerization step | | | | | | | | |
|---|---|---|---|---|---|---|---|---|---|
| | (part by weight) | | | | | | after polymerization | | |
| | monomer | | | polyvinyl | | | (part by weight) | | |
| | Vinyl | ethyl | butyl | alcohol | polyvinyl | hydrophilic | | | hydrophilic |
| | Acetate | acrylate | acrylate | (C1) *1 | alcohol *1 | substance *2 | pheromone | | substance *2 |
| Example 1 | 100 | — | — | 6(P) | — | — | OFM | 5 | 8(N) |
| Example 2 | 100 | — | — | 20(P) | — | — | OFM | 5 | 6.5(N) |
| Example 3 | 100 | — | — | 6(A) | — | — | OFM | 5 | 6(N) |
| Example 4 | 100 | — | — | 6(P) | — | — | CDM | 5 | 8(N) |
| Example 5 | 100 | — | — | 6(P) | — | — | GM | 5 | 8(N) |
| Example 6 | 100 | — | — | 6(P) | — | — | PTwB | 5 | 8(N) |
| Example 7 | 100 | — | — | 6(P) | — | — | PBW | 5 | 8(N) |
| Example 8 | 100 | — | — | 6(P) | — | — | OFM | 5 | 8(N60) |
| Example 9 | 50 | — | 50 | 6(P) | — | — | OFM | 5 | 0.8(N) |
| Example10 | — | 20 | 80 | 8(P) | — | — | OFM | 5 | 1.5(N) |
| Example11 | 100 | — | — | 6(P) | — | 8(N) | OFM | 5 | — |
| Example12 | 100 | — | — | 6(P) | — | — | OFM | 3.5 | 8(N) |
| Example13 | 100 | — | — | 6(P) | — | — | OFM | 10 | 8(N) |
| Example14 | 100 | — | — | 10(P) | — | — | OFM | 5 | 3(G) |
| Example15 | 100 | — | — | 2(P) | — | 16(N) | OFM | 5 | — |
| Comp. Ex. 1 | 100 | — | — | 6(P) | — | — | OFM | 5 | 22(N) |
| Comp. Ex. 2 | 100 | — | — | 33(P) | — | — | OFM | 5 | 5(N) |
| Comp. Ex. 3 | 100 | — | — | 6(P) | — | — | OFM | 5 | — |
| Comp. Ex. 4 | 100 | — | — | — | 6(L) | — | OFM | 5 | 3(N) |
| Comp. Ex. 5 | 100 | — | — | — | — | 5(EL) | OFM | 5 | — |

*1 As the polyvinyl alcohol, “L” represents JL-05E having a degree of saponification of 82 mol %, “P” represents JP-05 having a degree of saponification of 88 mol %, and “A” represents PVA-706 having a degree of saponification of 91.5 mol %.
*2 As a hydrophilic substance, “N” represents NOIGEN XL-160, “N60” represents NOIGEN XL-60, “EL” represents PERSOFT EL and “G” represents glycerin.

TABLE 2

| | | | | | | remaining amount of volatile active substance | | | | |
|---|---|---|---|---|---|---|---|---|---|---|
| | | | | | | weight ratio relative to the initial amount | | | | |
| | | | | | | | | | | the day when |
| | | glass transition | | | | | | | | remaining amount |
| | molar ratio of | temperature | | evaporation | | 10 | 20 | 30 | 40 | reached not |
| | hydrophilic part | of polymer *3 | viscosity | residue | weather | days | days | days | days | more than 5% |
| | to acetate part | (° C.) | (mPa · s) | (%) | resistance | later *4 | later *4 | later *4 | later *4 | (day) |
| Example 1 | 8.0 | 30 | 50 | 40 | High | 75 | 58 | 39 | 31 | 100 |
| Example 2 | 7.5 | 30 | 80 | 37.7 | High | 74 | 56 | 37 | 29 | 97 |
| Example 3 | 11.4 | 30 | 40 | 40 | High | 67 | 50 | 32 | 24 | 84 |
| Example 4 | 8.0 | 30 | 60 | 40 | High | 75 | 56 | 37 | 30 | 94 |
| Example 5 | 8.0 | 30 | 60 | 40 | High | 68 | 52 | 34 | 26 | 86 |
| Example 6 | 8.0 | 30 | 60 | 40 | High | 69 | 51 | 32 | 26 | 86 |
| Example 7 | 8.0 | 30 | 60 | 40 | High | 70 | 52 | 34 | 27 | 89 |
| Example 8 | 8.6 | 30 | 60 | 40 | High | 75 | 57 | 38 | 30 | 100 |
| Example 9 | 7.4 | −17 | 80 | 40 | High | 68 | 53 | 38 | 31 | 97 |
| Example 10 | 7.4 | −47 | 80 | 40 | High | 67 | 53 | 37 | 29 | 94 |
| Example 11 | 8.0 | 30 | 70 | 41.4 | High | 72 | 56 | 34 | 29 | 94 |
| Example 12 | 8.0 | 30 | 50 | 40 | High | 75 | 59 | 39 | 32 | 104 |
| Example 13 | 8.0 | 30 | 50 | 40 | High | 65 | 52 | 37 | 27 | 91 |
| Example 14 | 8.7 | 30 | 50 | 40 | High | 68 | 54 | 35 | 25 | 89 |
| Example 15 | 11.1 | 30 | 60 | 40 | High | 50 | 40 | 23 | 15 | 70 |
| Comp. Ex. 1 | 9.1 | 30 | 60 | 40 | Low | 44 | 35 | 25 | 22 | 85 |
| Comp. Ex. 2 | 7.4 | 30 | 90 | 36.5 | Low | 99 | 98 | 97 | 97 | not measurable |
| Comp. Ex. 3 | 7.3 | 30 | 80 | 40 | High | 93 | 94 | 93 | 93 | not measurable |
| Comp. Ex. 4 | 4.7 | 30 | 60 | 40 | High | 34 | 22 | 15 | 15 | 64 |
| Comp. Ex. 5 | — | 30 | 70 | 51 | High | 76 | 73 | 72 | 72 | not measurable |

*3 value obtained by calculation based on equation (1).
*4 weight ratio relative to the initial amount which is regarded as 100.

Table 2 shows the results relating to the sustained release preparation comprising polymer particles obtained by polymerizing the ethylenically unsaturated group-containing monomers (A), the hydrophilic substance (B), and polyvinyl alcohol (C1) having a degree of saponification of more than 82 mol % but not more than 91.5 mol %.

In Comparative Example 1 for the sustained release preparation comprising the hydrophilic substance (B) in an amount of 22% by weight relative to the total amount of the ethylenically unsaturated group-containing monomers (A), weather resistance was inferior, and a half thereof was released in the first ten days, preventing a uniform release. In Comparative Example 2 for the sustained release preparation comprising the polyvinyl alcohol (C1) in an amount of 33% by weight relative to the total amount of the ethylenically unsaturated group-containing monomers (A), weather resistance was inferior, and also, the sustained release preparation was hardly released over 40 days. In Comparative Example 3 for the sustained release preparation comprising the polyvinyl alcohol (C1) but not comprising a hydrophilic substance (B), the sustained release preparation were hardly released over forty days. In Comparative Example 4 for the sustained release preparation comprising the polyvinyl alcohol having a degree of saponification of 82 mol % but not comprising polyvinyl alcohol (C) having a degree of saponification of more than 82 mol %, 66% thereof was released in the first ten days, preventing a uniform release. In Comparative Example 5 for the sustained release preparation not comprising the polyvinyl alcohol at all, 24% thereof was released in an early stage, and the rest was hardly released thereafter.

As for the sustained release preparation in Example 15 having a ratio (a molar ratio of hydrophilic part/acetate part) of a molar amount of the hydrophilic part to a molar amount of the acetate part in the hydrophilic substance (B) and the polyvinyl alcohol (C1) was 16.0, a half thereof was released in the first ten days, and uniform release was achieved thereafter.

### Example 16

The 70 parts by weight of ion-exchanged water was placed in a four-necked glass flask equipped with a stirrer, a reflux condenser and a thermometer, and air displacement with nitrogen was sufficiently performed in the flask. Then stirring was started. The temperature inside the flask was raised to 75° C., and 0.5 parts by weight of sodium persulfate was added thereto as a polymerization initiator.

The 100 parts by weight of vinyl acetate monomers, 50 parts by weight of aqueous 20 wt % solution of PVA (JT-05 produced by Japan VAM & POVAL Co., Ltd., a degree of saponification of 94 mol %, an average polymerization degree of 500), which was 10% by weight relative to the vinyl acetate monomers, and 70 parts by weight of ion-exchanged water were placed and stirred in a homo-mixer for 5 minutes to prepare a emulsion of monomers. After the emulsion was added dropwise into the four-necked flask for 4 hours, the polymerization was further continued for 2 hours. Then, the resulting mixture was reacted at 80° C. for 1 hour and cooled to 30° C. A polyvinyl acetate particle water dispersion having 38.2% by weight of evaporation residue and viscosity of 60 mPa·s was obtained.

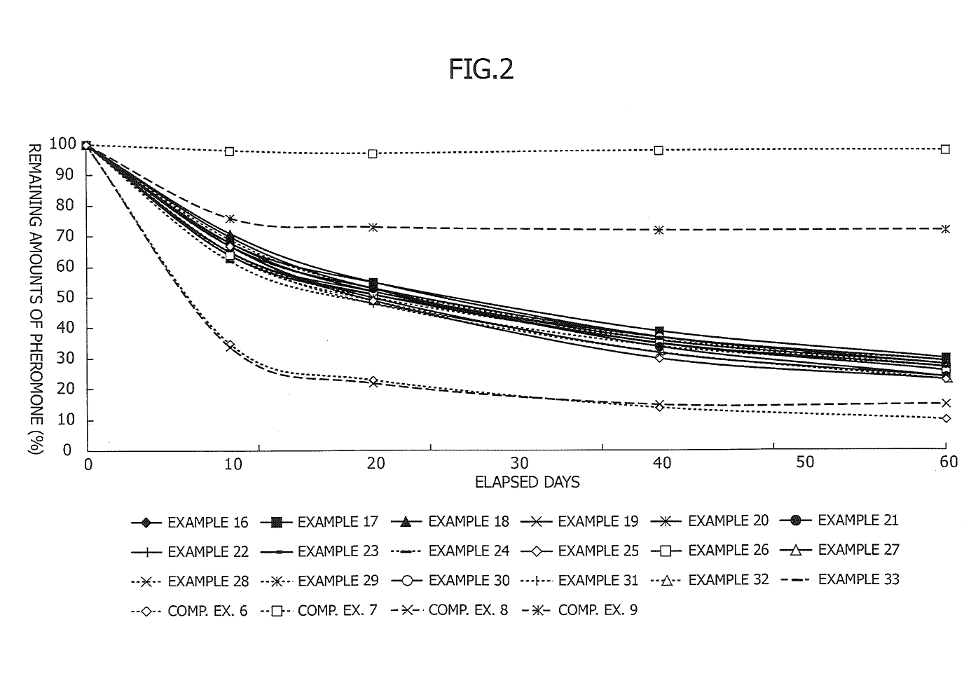

To the water dispersion, 5 parts by weight of Z-8-dodecenyl acetate (product of Shin-Etsu Chemical Co., Ltd., boiling point of 300° C.) as sex pheromone of OFM was added. The mixture was stirred at 25° C. for 1 hour. Thereafter, 10 parts by weight of aqueous 80 wt % solution of surfactant (non-ionic surfactant NOIGEN XL-160 produced by Dai-ichi Kogyo Seiyaku Co., Ltd, molecular weight of 862), which was 8% by weight relative to the vinyl acetate monomers, was added thereto. The mixture was further stirred at 25° C. for 30 minutes to produce a sustained release preparation. The same tests as those in Example 1 were conducted. The composition in each step is shown in Table 3, and the results are shown in Table 4 and FIG. 2.

### Examples 17 to 33 and Comparative Examples 6 to 9

The polymer particle water dispersion and the sustained release preparation were produced based on the polymerization compositions with an addition after the polymerization as shown in Table 3 in the same manner as in Example 1. Then the same tests as those in Example 1 were conducted. The used PVA included JT-05 (product of Japan VAM & POVAL Co., Ltd., a degree of saponification of 94 mol %, an average polymerization degree of 500), JM-17L (product of Japan VAM & POVAL Co., Ltd., a degree of saponification of 96 mol %, an average polymerization degree of 1700), and JL-05E (product of Japan VAM & POVAL Co., Ltd., a degree of saponification of 82 mol %, an average polymerization degree of 500). The used sex pheromone included Z-8-dodecenyl acetate (product of Shin-Etsu Chemical Co., Ltd., boiling point of 300° C.) as sex pheromone of OFM, E,E-8,10-dodecadienol (product of Shin-Etsu Chemical Co., Ltd., boiling point of 271° C.) as sex pheromone of CDM, (±)-cis-7,8-epoxy-2-methyloctadecane (product of Shin-Etsu Chemical Co., Ltd., boiling point of 332° C.) as sex pheromone of GM, E-5-dodecenyl acetate (product of Shin-Etsu Chemical Co., Ltd., boiling point of 211° C.) as sex pheromone of PTwB, and ZZ/ZE-7,11-hexadecadienyl acetate (product of Shin-Etsu Chemical Co., Ltd., boiling point of 349° C.) as sex pheromone of PBW. The used hydrophilic substance included NOIGEN XL-60 (non-ionic surfactant produced by Dai-ichi Kogyo Seiyaku Co., Ltd., polyoxyalkylene branched decyl ether, molecular weight of 422), NOIGEN XL-160 (non-ionic surfactant produced by Dai-ichi Kogyo Seiyaku Co., Ltd, polyoxyalkylene branched decyl ether, molecular weight of 862), SHINORINE 100 (anionic surfactant produced by New Japan Chemical Co., Ltd., sodium lauryl sulfate salt, molecular weight: 288), PERSOFT EL (anionic surfactant produced by NOF Corporation, polyoxyethylene-alkyl ether-sodium sulfate, molecular weight of 420), and urea (molecular weight of 60.6). The results are shown in Table 4 and FIG. 2.

TABLE 3

| | polymerization step | | | | | | after polymerization | | | |
|---|---|---|---|---|---|---|---|---|---|---|
| | (part by weight) | | | | | | (part by weight) | | | |
| | monomer | | | Polyvinyl | | | | | polyvinyl | |
| | vinyl | ethyl | butyl | Alcohol | polyvinyl | hydrophilic | | | alcohol | hydrophilic |
| | acetate | acrylate | acrylate | (C2) *1 | alcohol *1 | substance*2 | pheromone | | (C2) *1 | substance *2 |
| Example 16 | 100 | — | — | 10(T) | — | — | OFM | 5 | — | 8(N) |
| Example 17 | 100 | — | — | 25(T) | — | — | OFM | 5 | — | 10(N) |
| Example 18 | 100 | — | — | 10(T) | — | — | OFM | 5 | — | 10(S) |
| Example 19 | 100 | — | — | 10(M) | — | — | OFM | 5 | — | 0.5(N) |
| Example 20 | 100 | — | — | 10(M) | — | — | OFM | 5 | — | 0.5(N60) |
| Example 21 | 100 | — | — | 10(T) | — | — | CDM | 5 | — | 8(N) |
| Example 22 | 100 | — | — | 10(T) | — | — | GM | 5 | — | 8(N) |
| Example 23 | 100 | — | — | 10(T) | — | — | PTwB | 5 | — | 8(N) |
| Example 24 | 100 | — | — | 10(T) | — | — | PBW | 5 | — | 8(N) |
| Example 25 | 100 | — | — | 10(T) | — | — | OFM | 3.4 | — | 8(N) |
| Example 26 | 100 | — | — | 10(T) | — | — | OFM | 10 | — | 8(N) |
| Example 27 | 50 | — | 50 | 10(T) | — | — | OFM | 5 | — | 0.5(N) |
| Example 28 | — | 20 | 80 | 10(T) | — | — | OFM | 5 | — | 0.2(N) |
| Example 29 | 100 | — | — | 10(T) | — | 5(N) | OFM | 5 | — | — |
| Example 30 | — | 20 | 80 | — | — | 5(N) | OFM | 5 | 10(T) | — |
| Example 31 | — | 20 | 80 | 10(M) | — | — | OFM | 5 | — | 0.2(N) |
| Example 32 | 50 | 50 | — | 10(T) | — | — | OFM | 5 | — | 1(N) |
| Example 33 | 80 | — | 20 | 12(T) | — | — | OFM | 5 | — | 8(U) |
| Comp. Ex. 6 | 100 | — | — | 6(T) | — | — | OFM | 5 | — | 22(N) |
| Comp. Ex. 7 | 100 | — | — | 33(T) | — | — | OFM | 5 | — | 5(N) |
| Comp. Ex. 8 | 100 | — | — | — | 6(L) | — | OFM | 5 | — | 3(N) |
| Comp. Ex. 9 | 100 | — | — | — | — | 5(EL) | OFM | 5 | — | — |

*1 As the polyvinyl alcohol, “L” represents JL-05E having a degree of saponification of 82 mol %, “T” represents JT-05 having a degree of saponification of 94 mol %, and “M” represents JM-17L having a degree of saponification of 96 mol %.
*2 As a hydrophilic substance, “N” represents NOIGEN XL-160, “N60” represents NOIGEN XL-60, “S” represents SHINORINE 100, “U” represents urea, and “EL” represents PERSOFT EL.

TABLE 4

| | | | | | | remaining amount of volatile active substance | | | | |
|---|---|---|---|---|---|---|---|---|---|---|
| | | | | | | weight ratio relative to the initial amount | | | | |
| | molar ratio of | glass transition | | | | | | | | the day when remaining |
| | hydrophilic | temperature | | evaporation | | 10 | 20 | 30 | 40 | amount reached |
| | part | of polymer *3 | Viscosity | residue | weather | days | days | days | days | not more than 5% |
| | to acetate part | (° C.) | (mPa · s) | (%) | resistance | later *4 | later *4 | later *4 | later *4 | (day) |
| Example 16 | 16.4 | 30 | 60 | 38.2 | High | 65 | 52 | 36 | 28 | 91 |
| Example 17 | 16.0 | 30 | 70 | 35.8 | High | 68 | 55 | 39 | 30 | 97 |
| Example 18 | 18.4 | 30 | 40 | 38.6 | High | 71 | 55 | 37 | 29 | 94 |
| Example 19 | 24.1 | 30 | 50 | 32.8 | High | 68 | 52 | 35 | 27 | 91 |
| Example 20 | 24.1 | 30 | 60 | 32.8 | High | 67 | 50 | 32 | 24 | 86 |
| Example 21 | 16.4 | 30 | 80 | 38.6 | High | 70 | 53 | 34 | 24 | 86 |
| Example 22 | 16.4 | 30 | 80 | 38.6 | High | 67 | 53 | 37 | 29 | 94 |
| Example 23 | 16.4 | 30 | 50 | 38.6 | High | 65 | 51 | 35 | 27 | 89 |
| Example 24 | 16.4 | 30 | 70 | 38.6 | High | 62 | 48 | 34 | 27 | 86 |
| Example 25 | 16.4 | 30 | 65 | 38.6 | High | 67 | 49 | 30 | 23 | 79 |
| Example 26 | 16.4 | 30 | 50 | 38.6 | High | 64 | 51 | 35 | 26 | 86 |
| Example 27 | 15.7 | −17 | 70 | 38.5 | High | 68 | 52 | 35 | 27 | 91 |
| Example 28 | 15.7 | −47 | 60 | 38.5 | High | 69 | 53 | 36 | 27 | 91 |
| Example 29 | 16.1 | 30 | 80 | 45.0 | High | 65 | 50 | 36 | 29 | 91 |
| Example 30 | 16.1 | 10 | 60 | 43.5 | High | 64 | 51 | 37 | 28 | 91 |
| Example 31 | 24.0 | −47 | 40 | 32.8 | High | 65 | 48 | 32 | 23 | 86 |
| Example 32 | 15.8 | −9 | 50 | 38.6 | High | 64 | 49 | 32 | 23 | 81 |
| Example 33 | 24.2 | 8 | 60 | 40.0 | High | 67 | 53 | 37 | 28 | 94 |
| Comp. Ex. 6 | 19.0 | 30 | 70 | 40.0 | Low | 35 | 23 | 14 | 10 | 51 |
| Comp. Ex. 7 | 15.8 | 30 | 60 | 36.5 | Low | 98 | 97 | 98 | 98 | not measurable |
| Comp. Ex. 8 | 4.7 | 30 | 60 | 40.0 | High | 34 | 22 | 15 | 15 | 64 |
| Comp. Ex. 9 | — | 30 | 75 | 42.0 | High | 76 | 73 | 72 | 72 | not measurable |

*3 value obtained by calculation based on equation (1).
*4 weight ratio relative to the initial amount which is regarded as 100.

Table 4 shows the results relating to the sustained release preparation comprising the polymer particles obtained by polymerizing the ethylenically unsaturated group-containing monomers (A), the hydrophilic substance (B), and the polyvinyl alcohol (C2) having a degree of saponification of more than 91.5 mol % and less than 98 mol %.

In Comparative Example 6 for the sustained release preparation comprising the hydrophilic substance (B) in an amount of 22% by weight relative to the total amount of the ethylenically unsaturated group-containing monomers (A), weather resistance was inferior, and also 65% thereof was released in the first ten days, preventing a uniform release. In Comparative Example 7 for the sustained release preparation comprising the polyvinyl alcohol (C2) in an amount of 33% by weight relative to the total amount of the ethylenically unsaturated group-containing monomers (A), weather resistance was inferior, and also, the sustained release preparation was hardly released over forty days. In Comparative Example 8 for the sustained release preparation comprising the polyvinyl alcohol having a degree of saponification of 82 mol % and not comprising the polyvinyl alcohol (C) having a degree of saponification of more than 82 mol %, 66% thereof was released in the first ten days, preventing a uniform release. In Comparative Example 9 for the sustained release preparation not comprising the polyvinyl alcohol at all, 24% thereof was released in the early stage, and the rest was hardly released thereafter.

### Example 34

The 100 parts by weight of ion-exchanged water was placed in a four-necked glass flask equipped with a stirrer, a reflux condenser and a thermometer, and air displacement with nitrogen was sufficiently performed in the flask. Then stirring was started. The temperature inside the flask was raised to 75° C., and 0.5 parts by weight of sodium persulfate was added thereto as a polymerization initiator. The 100 parts by weight of vinyl acetate monomers, 130 parts by weight of aqueous 10 wt % solution of PVA (JF-17 produced by Japan VAM & POVAL Co., Ltd., a degree of saponification of 98.5 mol %, an average polymerization degree of 1700), which was 13% by weight relative to the vinyl acetate monomers, 3.75 parts by weight of aqueous 80 wt % solution of surfactant (non-ionic surfactant NOIGEN XL-160 produced by Dai-ichi Kogyo Seiyaku Co., Ltd, molecular weight: 862), which was 3% by weight relative to the vinyl acetate monomers, and 20 parts by weight of ion-exchanged water were placed and stirred in a homo-mixer for 5 minutes to prepare a emulsion of monomers. After the emulsion was added dropwise into the four-necked flask for 4 hours, the polymerization was further continued for 2 hours. Then, the resulting mixture was reacted at 80° C. for 1 hour and cooled to 30° C. A polyvinyl acetate particle water dispersion having 32.8% by weight of evaporation residue and viscosity of 70 mPa·s was obtained.

To the water dispersion, 5 parts by weight of Z-8-dodecenyl acetate (product of Shin-Etsu Chemical Co., Ltd., boiling point of 300° C.) as sex pheromone of OFM was added. The mixture was stirred at 25° C. for 1 hour. Thereafter, 3.75 parts by weight of aqueous 80 wt % solution of surfactant (non-ionic surfactant NOIGEN XL-160 produced by Dai-ichi Kogyo Seiyaku Co., Ltd, molecular weight of 862), which was 3% by weight relative to the vinyl acetate monomers, was added thereto. The mixture was further stirred at 25° C. for 30 minutes to produce a sustained release preparation.

The molar ratio of hydrophilic part to acetate part is as follows.

$$\begin{matrix}Molar amount of hydrophilic part = [ 13 \times ( 44 \times 0.985 ) / \{ 44 \times 0.985 + 86 \times ( 1 - 0.985 ) \} ] / 44 + 6 / 862 \\ = 0.29387\end{matrix}$$

$$\begin{matrix}Molar amount of acetate part = 13 \times 86 \times ( 1 - 0.985 ) / \{ 44 \times 0.985 + 86 \times ( 1 - 0.985 ) \} / 86 \\ = 0.00437\end{matrix}$$

$$\begin{matrix}Molar ratio of hydrophilic part to acetate part = 0.29387 / 0.00437 \\ = 67.2\end{matrix}$$

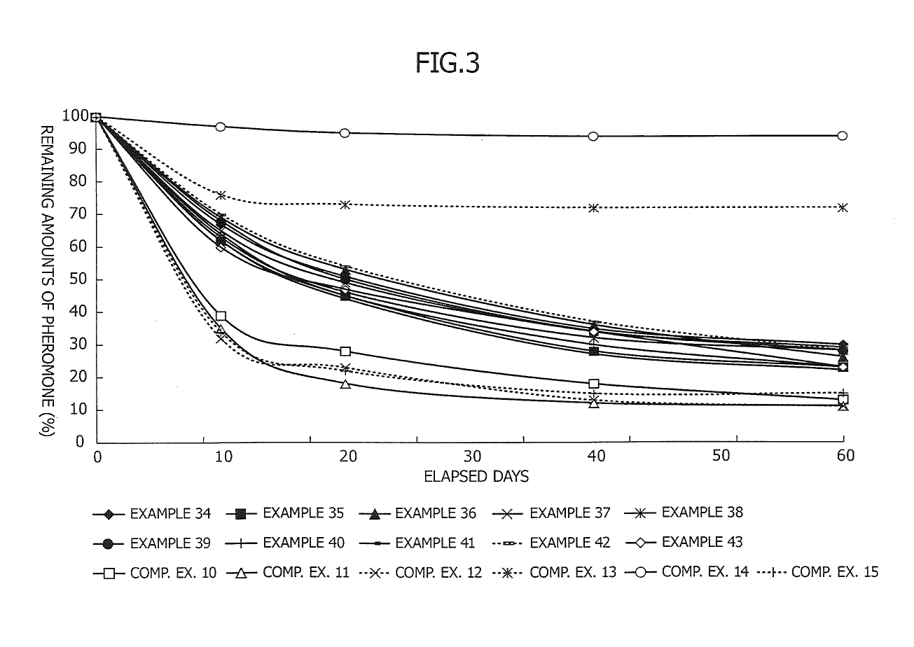

The composition in each step is shown in Table 5, and the results of the analyses and tests are shown in Table 6 and FIG. 3.

### Examples 35 to 43 and Comparative Examples 10 to 15

The polymer particle water dispersion and the sustained release preparation were produced based on the polymerization compositions with an addition after the polymerization as shown in Table 5 in the same manner as in Example 1. Then the same tests as those in Example 1 were conducted. The used PVA included JF-05 (product of Japan VAM & POVAL Co., Ltd., a degree of saponification of 98.5 mol %, an average polymerization degree of 500), and JF-17 (product of Japan VAM & POVAL Co., Ltd., a degree of saponification of 98.5 mol %, an average polymerization degree of 1700). The used sex pheromone included Z-8-dodecenyl acetate (product of Shin-Etsu Chemical Co., Ltd., boiling point of 300° C.) as sex pheromone of OFM, E,E-8,10-dodecadienol (product of Shin-Etsu Chemical Co., Ltd., boiling point of 271° C.) as sex pheromone of CDM, (±)-cis-7,8-epoxy-2-methyloctadecane (product of Shin-Etsu Chemical Co., Ltd., boiling point of 332° C.) as sex pheromone of GM, E-5-dodecenyl acetate (product of Shin-Etsu Chemical Co., Ltd., boiling point of 211° C.) as sex pheromone of PTwB, and ZZ/ZE-7,11-hexadecadienyl acetate (product of Shin-Etsu Chemical Co., Ltd., boiling point of 349° C.) as sex pheromone of PBW. The used hydrophilic substance included NOIGEN XL-60 (non-ionic surfactant produced by Dai-ichi Kogyo Seiyaku Co., Ltd., molecular weight of 422), NOIGEN XL-160 (non-ionic surfactant produced by Dai-ichi Kogyo Seiyaku Co., Ltd, molecular weight of 862), and SHINORINE 100 (anionic surfactant produced by New Japan Chemical Co., Ltd., molecular weight: 288). The results are shown in Table 6 and FIG. 3.

TABLE 5

| | polymerization step | | | | | after polymerization | | |
|---|---|---|---|---|---|---|---|---|
| | (part by weight) | | | | | (part by weight) | | |
| | monomer | | polyvinyl | | | | | |
| | vinyl | butyl | alcohol | polyvinyl | hydrophilic | | | hydrophilic |
| | acetate | acrylate | (C3) *1 | alcohol *1 | substance *2 | pheromone | | substance *2 |
| Example 34 | 100 | — | 13(F17) | — | 3(N) | OFM | 5 | 3(N) |
| Example 35 | 100 | — | 13(F17) | — | 3(N) | CDM | 5 | 3(N) |
| Example 36 | 75 | 25 | 8(F17) | — | — | OFM | 5 | 1(N) |
| Example 37 | 80 | 20 | 13(F17) | — | 3(N) | GM | 5 | 3(N) |
| Example 38 | 80 | 20 | 13(F17) | — | 3(N) | PTwB | 5 | 3(N) |
| Example 39 | 80 | 20 | 13(F17) | — | 3(N) | PBW | 5 | 3(N60) |
| Example 40 | 80 | 20 | 8(F17) | — | — | OFM | 3.5 | 1(N) |
| Example 41 | 80 | 20 | 8(F17) | — | — | OFM | 10 | 1(N) |
| Example 42 | 80 | 20 | 10(F05) | — | 4.5(N) | OFM | 5 | — |
| Example 43 | 75 | 25 | 8(F17) | — | — | OFM | 10 | 1(N) |
| Comp. Ex. 10 | 100 | — | 32(F17) | — | — | OFM | 5 | 10(N) |
| Comp. Ex. 11 | 100 | — | 10(F17) | — | — | OFM | 5 | 23(N) |
| Comp. Ex. 12 | 100 | — | 8(F17) | — | 10(S) | OFM | 5 | 12(S) |
| Comp. Ex. 13 | 100 | — | — | — | 5(EL) | OFM | 5 | — |
| Comp. Ex. 14 | 100 | — | 5(F17) | — | — | OFM | 5 | — |
| Comp. Ex. 15 | 100 | — | — | 6(L) | — | OFM | 5 | 3(N) |

*1 As the polyvinyl alcohol, “F” represents JF-17 having a degree of saponification of 98.5 mol %, and “F2” represents JF-05 having a degree of saponification of 98.5 mol %.
*2 As a hydrophilic substance, “N” represents NOIGEN XL-160, “N60” represents NOIGEN XL-60, “S” represents SHINORINE 100 and “EL” represents PERSOFT EL.

TABLE 6

| | | | | | | remaining amount of volatile active substance | | | | |
|---|---|---|---|---|---|---|---|---|---|---|
| | | | | | | weight ratio relative to the initial amount | | | | |
| | | | | | | | | | | the day |
| | | glass transition | | | | | | | | when remaining |
| | molar ratio of | temperature | | evaporation | | 10 | 20 | 30 | 40 | amount reached |
| | hydrophilic part | of polymer *3 | viscosity | residue | weather | days | days | days | days | not more than 5% |
| | to acetate part | (° C.) | (mPa · s) | (%) | resistance | later *4 | later *4 | later *4 | later *4 | (day) |
| Example 34 | 67.3 | 30 | 70 | 32.8 | High | 67 | 51 | 35 | 30 | 94 |
| Example 35 | 67.3 | 30 | 70 | 32.8 | High | 62 | 45 | 28 | 23 | 97 |
| Example 36 | 66.1 | 3 | 80 | 40.3 | High | 69 | 53 | 36 | 26 | 89 |
| Example 37 | 67.3 | 8 | 65 | 32.8 | High | 65 | 49 | 34 | 29 | 91 |
| Example 38 | 67.3 | 8 | 65 | 32.8 | High | 63 | 46 | 32 | 28 | 86 |
| Example 39 | 68.1 | 8 | 65 | 32.8 | High | 68 | 50 | 34 | 28 | 89 |
| Example 40 | 66.1 | 8 | 85 | 40.3 | High | 64 | 45 | 30 | 23 | 79 |
| Example 41 | 66.1 | 8 | 85 | 40.3 | High | 62 | 44 | 27 | 22 | 75 |
| Example 42 | 67.2 | 8 | 90 | 45.1 | High | 70 | 54 | 37 | 28 | 94 |
| Example 43 | 66.1 | 3 | 90 | 40.3 | High | 60 | 47 | 34 | 23 | 81 |
| Comp. Ex. 10 | 66.7 | 30 | 54 | 26.1 | Low | 39 | 28 | 18 | 13 | 57 |
| Comp. Ex. 11 | 73.6 | 30 | 70 | 38.2 | Low | 35 | 18 | 12 | 11 | 52 |
| Comp. Ex. 12 | 94.0 | 30 | 60 | 34.0 | Low | 32 | 23 | 13 | 11 | 54 |
| Comp. Ex. 13 | — | 30 | 75 | 42.0 | High | 76 | 73 | 72 | 72 | not measurable |
| Comp. Ex. 14 | 65.7 | 30 | 60 | 35.6 | High | 97 | 95 | 94 | 94 | not measurable |
| Comp. Ex. 15 | 4.7 | 30 | 60 | 40.0 | High | 34 | 22 | 15 | 15 | 64 |

*3 value obtained by calculation based on equation (1).
*4 weight ratio relative to the initial amount which is regarded as 100.

Table 6 shows the results relating to the sustained release preparation comprising the polymer particles obtained by polymerizing the ethylenically unsaturated group-containing monomers (A), the hydrophilic substance (B), and polyvinyl alcohol (C3) having a degree of saponification of not less than 98 mol %.

In Comparative Example 10 for the sustained release preparation comprising the polyvinyl alcohol (C3) in an amount of 32% by weight relative to the total amount of the ethylenically unsaturated group-containing monomers (A), weather resistance was inferior, and 61% thereof was released in the first ten days, preventing a uniform release. In Comparative Example 11 for the sustained release preparation comprising the hydrophilic substance (B) in an amount of 23% by weight relative to the total amount of the ethylenically unsaturated group-containing monomers (A), weather resistance was inferior, and 65% thereof was released in the first ten days, preventing a uniform release. In Comparative Example 13 for the sustained release preparation comprising the hydrophilic substance (B) in an amount of 110% by weight relative to the total amount of the ethylenically unsaturated group-containing monomers (A), weather resistance was inferior, and 68% thereof was released in the first ten days, preventing a uniform release. In Comparative Example 15 for the sustained release preparation not comprising the polyvinyl alcohol at all, 24% thereof was released in the early stage, and the rest was hardly released thereafter. In Comparative Example 14 for the sustained release preparation comprising the polyvinyl alcohol (C3) and not comprising the hydrophilic substance (B), the sustained release preparation was hardly released over 40 days. In Comparative Examples 15 for the sustained release preparation comprising the polyvinyl alcohol having a degree of saponification of 82 mol % and not comprising the polyvinyl alcohol (C) having a degree of saponification of more than 82 mol %, 66% thereof was released in the first ten days, preventing a uniform release.

### Examples 44 to 93 and Comparative Examples 16 to 44

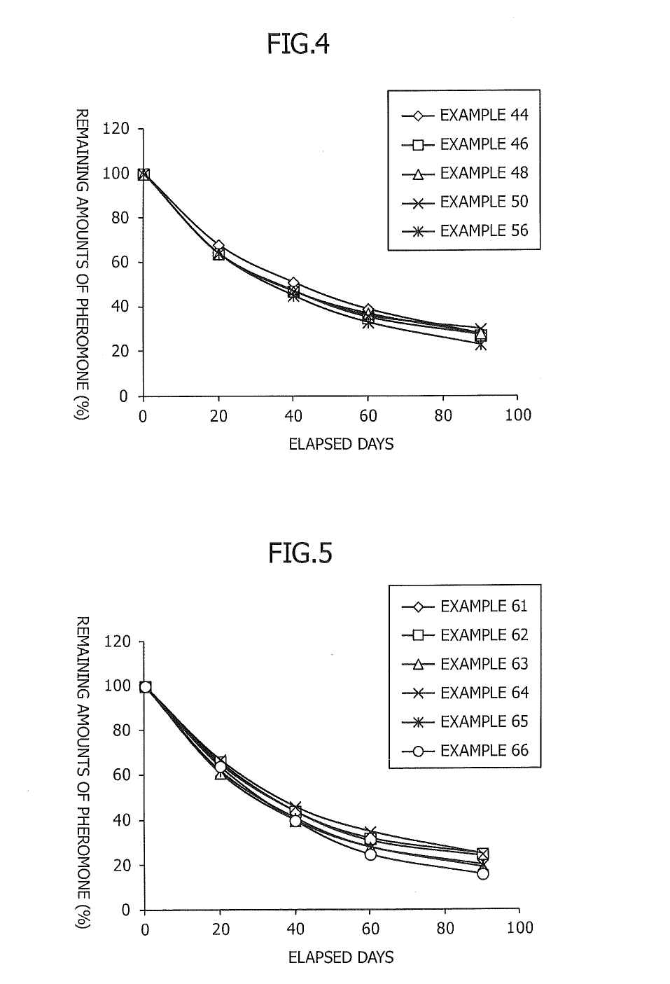

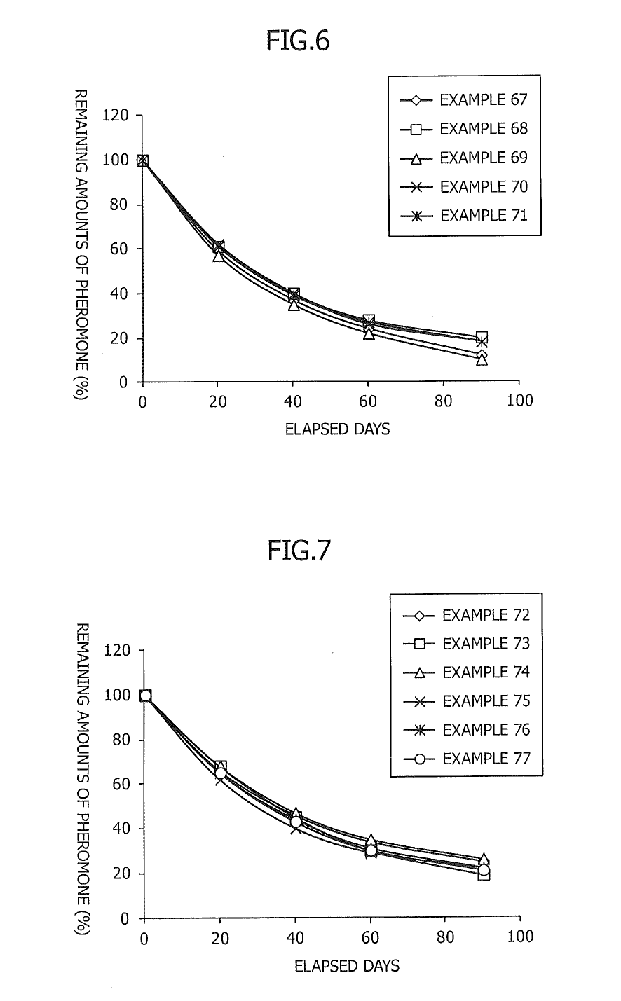

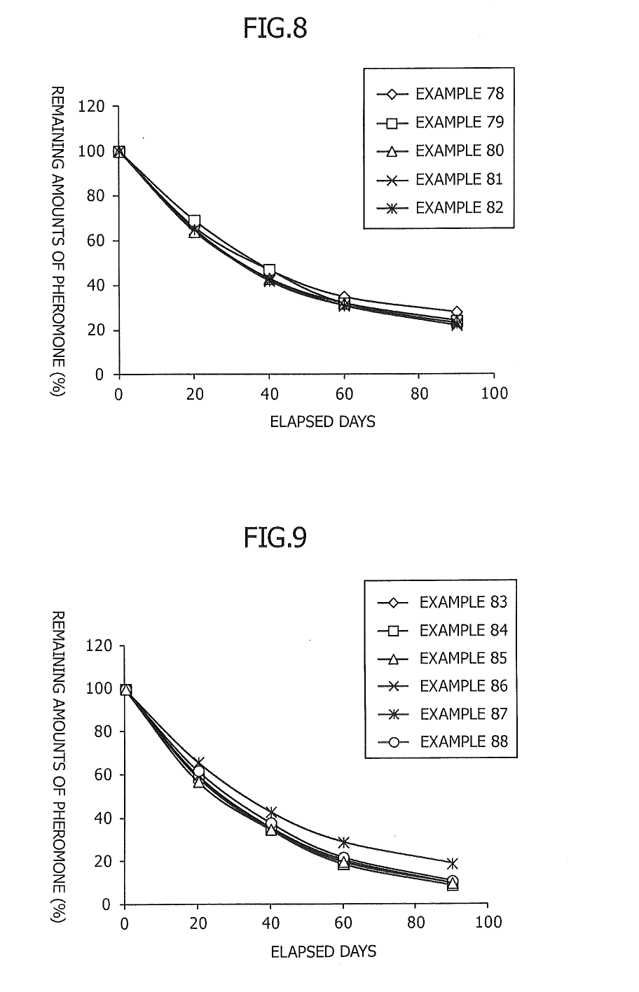

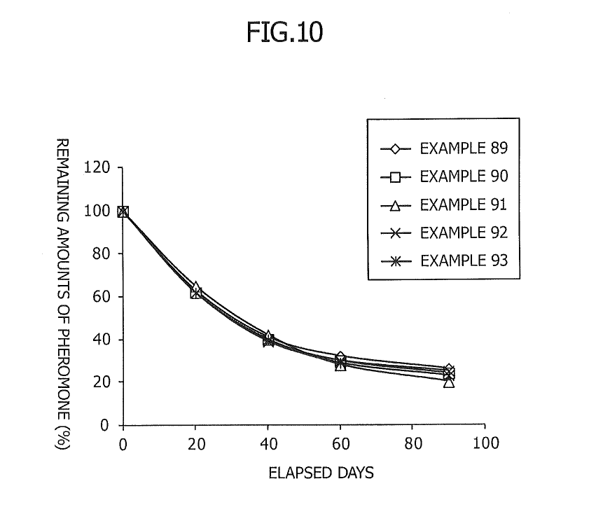

The polymer particle water dispersion and the sustained release preparation were produced based on the polymerization compositions with an addition after the polymerization as shown in Tables 7, 9, 11, 13 and 15 in the same manner as in Example 1. Then the same tests as those in Example 1 were conducted. The volatile active substance other than the sex pheromone included an aromatic such as leaf alcohol (boiling point of 156° C.), limonene (boiling point of 176° C.) and citral (boiling point of 229° C.), an agricultural chemical such as diazinon (decomposed at 120° C.), and a deodorant such as lauryl methacrylate (boiling point of 305° C.). The results are shown in Tables 8, 10, 12, 14 and 16 and FIGS. 4 to 10.

TABLE 7

| | polymerization step | | | | | | | after polymerization | | |
|---|---|---|---|---|---|---|---|---|---|---|
| | (part by weight) | | | | | | | (part by weight) | | |
| | monomer | | | | polyvinyl | | | volatile | | |
| | vinyl | butyl | acrylic | | alcohol | polyvinyl | hydrophilic | active | | hydrophilic |
| | acetate | acrylate | acid | ethylene | (C1) *1 | alcohol *1 | substance *2 | substance | | substance *2 |
| Example 44 | 55 | 43 | 2 | — | 15(P) | — | — | leaf alcohol | 6 | 8(EL) |
| Example 45 | 80 | — | — | 20 | 15(P) | — | — | leaf alcohol | 6 | 4(G) |
| Example 46 | 70 | 28 | 2 | — | 6(P) | — | — | limonene | 6 | 5(EL) |
| Example 47 | 75 | — | — | 25 | 17(P) | — | — | limonene | 6 | 3(G) |
| Example 48 | 65 | 33 | 2 | — | 8(P) | — | — | citral | 4 | 6(EL) |
| Example 49 | 70 | — | — | 30 | 18(P) | — | — | citral | 6 | 3(G) |
| Example 50 | 70 | 28 | 2 | — | 15(P) | — | — | diazinon | 6 | 5(EL) |
| Example 51 | 80 | — | — | 20 | 15(P) | — | — | diazinon | 6 | 4(G) |
| Comp. Ex. 16 | 55 | 43 | 2 | — | 6(P) | — | — | leaf alcohol | 6 | 22(N) |
| Comp. Ex. 17 | 55 | 43 | 2 | — | 33(P) | — | — | leaf alcohol | 6 | 5(N) |
| Comp. Ex. 18 | 80 | — | — | 20 | 6(P) | — | — | leaf alcohol | 6 | — |
| Comp. Ex. 19 | 70 | 28 | 2 | — | 6(P) | — | — | limonene | 6 | 22(N) |
| Comp. Ex. 20 | 70 | 28 | 2 | — | — | 6(L) | — | limonene | 6 | 3(N) |
| Comp. Ex. 21 | 75 | — | — | 25 | 33(P) | — | — | limonene | 6 | 5(N) |
| Comp. Ex. 22 | 65 | 33 | 2 | — | 6(P) | — | — | citral | 6 | 22(N) |
| Comp. Ex. 23 | 65 | 33 | 2 | — | — | — | 5(EL) | citral | 6 | — |
| Comp. Ex. 24 | 70 | — | — | 30 | 33(P) | — | — | citral | 6 | 5(N) |
| Comp. Ex. 25 | 70 | 28 | 2 | — | 6(P) | — | — | diazinon | 6 | 22(N) |
| Comp. Ex. 26 | 80 | — | — | 20 | 33(P) | — | — | diazinon | 6 | 5(N) |

*1 As the polyvinyl alcohol, “L” represents JL-05E having a degree of saponification of 82 mol %, and “P” represents JP-05 having a degree of saponification of 88 mol %.
*2 As a hydrophilic substance, “N” represents NOIGEN XL-160, “EL” represents PERSOFT EL, and “G” represents glycerin.

TABLE 8

| | | | | | | remaining amount of volatile active substance | | | | |
|---|---|---|---|---|---|---|---|---|---|---|
| | | | | | | weight ratio relative to the initial amount | | | | |
| | | | | | | | | | | the day |
| | | glass transition | | | | | | | | when remaining |
| | molar ratio of | temperature | | evaporation | | 20 | 40 | 60 | 90 | amount reached |
| | hydrophilic part | of polymer*3 | viscosity | residue | weather | days | days | days | days | not more than 5% |
| | to acetate part | (° C.) | (mPa · s) | (%) | resistance | later *4 | later *4 | later *4 | later *4 | (day) |
| Example 44 | 7.9 | 4 | 80 | 38.5 | — | 68 | 51 | 39 | 28 | 200 |
| Example 45 | 8.5 | 7 | 90 | 55.0 | — | 70 | 54 | 40 | 30 | 215 |
| Example 46 | 8.1 | 0 | 60 | 40.1 | — | 64 | 47 | 35 | 27 | 188 |
| Example 47 | 8.1 | −7 | 90 | 55.0 | — | 67 | 50 | 38 | 30 | 200 |
| Example 48 | 8.1 | −6 | 55 | 41.4 | — | 64 | 47 | 37 | 28 | 190 |
| Example 49 | 8.1 | −19 | 90 | 55.0 | — | 69 | 51 | 40 | 30 | 214 |
| Example 50 | 7.7 | 0 | 80 | 38.5 | High | 64 | 47 | 36 | 30 | 198 |
| Example 51 | 8.5 | 7 | 90 | 55.0 | High | 74 | 54 | 42 | 28 | 212 |
| Comp. Ex. 16 | 9.1 | 4 | 85 | 38.4 | — | 39 | 24 | 18 | 13 | 114 |
| Comp. Ex. 17 | 7.4 | 4 | 100 | 36.3 | — | 98 | 96 | 96 | 94 | not measurable |
| Comp. Ex. 18 | 7.3 | 7 | 90 | 54.6 | — | 97 | 95 | 94 | 94 | not measurable |
| Comp. Ex. 19 | 9.1 | 0 | 65 | 39.9 | — | 34 | 20 | 16 | 12 | 108 |
| Comp. Ex. 20 | 4.7 | 0 | 70 | 37.0 | — | 97 | 95 | 94 | 94 | not measurable |
| Comp. Ex. 21 | 7.4 | −7 | 90 | 54.4 | — | 38 | 22 | 15 | 15 | 117 |
| Comp. Ex. 22 | 9.1 | −6 | 60 | 41.1 | — | 39 | 25 | 18 | 16 | 119 |
| Comp. Ex. 23 | — | −19 | 65 | 50.2 | — | 76 | 71 | 70 | 70 | not measurable |
| Comp. Ex. 24 | 7.4 | −6 | 95 | 54.6 | — | 97 | 95 | 93 | 93 | not measurable |
| Comp. Ex. 25 | 9.1 | 0 | 85 | 38.2 | Low | 40 | 23 | 20 | 18 | 159 |
| Comp. Ex. 26 | 7.4 | 7 | 95 | 54.8 | Low | 97 | 95 | 94 | 94 | not measurable |

*3 value obtained by calculation based on equation (1).
*4 weight ratio relative to the initial amount which is regarded as 100.

TABLE 9

| | polymerization step | | | | | | after polymerization | | |
|---|---|---|---|---|---|---|---|---|---|
| | (part by weight) | | | | | | (part by weight) | | |
| | monomer | | | polyvinyl | | | volatile | | |
| | vinyl | butyl | acrylic | alcohol | polyvinyl | hydrophilic | active | | hydrophilic |
| | acetate | acrylate | acid | (C2) *1 | alcohol *1 | substance *2 | substance | | substance *2 |
| Example 52 | 70 | 28 | 2 | 10(T) | — | — | leaf alcohol | 4 | 4(UR) |
| Example 53 | 98 | — | 2 | 10(T) | — | — | leaf alcohol | 6 | 6(G) |
| Example 54 | 60 | 38 | 2 | 10(T) | — | — | limonene | 6 | 1(G) |
| Example 55 | 40 | 58 | 2 | 12(T) | — | — | citral | 4 | 3(G) |
| Example 56 | 70 | 28 | 2 | 8(T) | — | — | lauryl methacrylate | 6 | 2(EL) |
| Comp. Ex. 27 | 70 | 28 | 2 | 6(T) | — | — | leaf alcohol | 6 | 22(N) |
| Comp. Ex. 28 | 70 | 28 | 2 | 33(T) | — | — | leaf alcohol | 6 | 5(N) |
| Comp. Ex. 29 | 70 | 28 | 2 | — | 6(L) | — | leaf alcohol | 6 | 3(N) |
| Comp. Ex. 30 | 60 | 38 | 2 | 6(T) | — | — | limonene | 6 | 22(N) |
| Comp. Ex. 31 | 60 | 38 | 2 | — | — | 5(EL) | limonene | 6 | — |
| Comp. Ex. 32 | 40 | 58 | 2 | 6(T) | — | — | citral | 6 | 22(N) |
| Comp. Ex. 33 | 40 | 58 | 2 | 33(T) | — | — | citral | 6 | 5(N) |
| Comp. Ex. 34 | 70 | 28 | 2 | 6(T) | | — | lauryl methacrylate | 6 | 22(N) |
| Comp. Ex. 35 | 70 | 28 | 2 | 33(T) | — | — | lauryl methacrylate | 6 | 5(N) |

*1 As the polyvinyl alcohol, “L” represents JL-05E having a degree of saponification of 82 mol %, and “T” represents JT-05 having a degree of saponification of 94 mol %.
*2 As a hydrophilic substance, “N” represents NOIGEN XL-160, “UR” represents urea, “G” represents glycerin and “EL” represents PERSOFT EL.

TABLE 10

| | | | | | remaining amount of volatile active substance | | | | |
|---|---|---|---|---|---|---|---|---|---|
| | | | | | weight ratio relative to the initial amount | | | | |
| | | | | | | | | | the day when |
| | | glass transition | | | | | | | remaining |
| | molar ratio of | temperature | | evaporation | 20 | 40 | 60 | 90 | amount reached |
| | hydrophilic part | of polymer *3 | viscosity | residue | days | days | days | days | not more than 5% |
| | to acetate part | (° C.) | (mPa · s) | (%) | later *4 | later *4 | later *4 | later *4 | (day) |
| Example 52 | 20.8 | 0 | 60 | 40.7 | 63 | 46 | 36 | 28 | 188 |
| Example 53 | 20.7 | 30 | 65 | 40.7 | 69 | 50 | 39 | 29 | 200 |
| Example 54 | 16.5 | −10 | 55 | 40.7 | 63 | 43 | 31 | 24 | 167 |
| Example 55 | 17.8 | −25 | 65 | 39.9 | 65 | 47 | 36 | 27 | 186 |
| Example 56 | 16.1 | 0 | 50 | 41.4 | 64 | 45 | 33 | 23 | 177 |
| Comp. Ex. 27 | 19.0 | 0 | 70 | 41.0 | 38 | 22 | 14 | 10 | 111 |
| Comp. Ex. 28 | 15.8 | 0 | 60 | 37.5 | 98 | 97 | 97 | 97 | not measurable |
| Comp. Ex. 29 | 4.7 | 0 | 70 | 41.2 | 40 | 24 | 15 | 13 | 119 |
| Comp. Ex. 30 | 19.0 | −10 | 65 | 38.9 | 39 | 20 | 13 | 9 | 104 |
| Comp. Ex. 31 | — | −10 | 65 | 40.4 | 75 | 72 | 70 | 70 | not measurable |
| Comp. Ex. 32 | 19.0 | −25 | 70 | 38.4 | 41 | 19 | 13 | 10 | 110 |
| Comp. Ex. 33 | 15.8 | −25 | 75 | 39.6 | 96 | 95 | 93 | 93 | not measurable |
| Comp. Ex. 34 | 19.0 | 0 | 60 | 40.2 | 42 | 21 | 12 | 10 | 109 |
| Comp. Ex. 35 | 15.8 | 0 | 55 | 41.0 | 97 | 97 | 95 | 95 | not measurable |

*3 value obtained by calculation based on equation (1).
*4 weight ratio relative to the initial amount which is regarded as 100.

TABLE 11

| | polymerization step | | | | | after polymerization | | |
|---|---|---|---|---|---|---|---|---|
| | (part by weight) | | | | | (part by weight) | | |
| | monomer | | | polyvinyl | | volatile | | |
| | vinyl | butyl | acrylic | alcohol | polyvinyl | active | | hydrophilic |
| | acetate | acrylate | acid | (C3) *1 | alcohol *1 | substance | | substance *2 |
| Example 57 | 65 | 33 | 2 | 4(F05) | — | leaf alcohol | 6 | 6(EL) |
| Example 58 | 70 | 28 | 2 | 3(F05) | — | limonene | 6 | 8(EL) |
| Example 59 | 55 | 43 | 2 | 2(F05) | — | citral | 6 | 8(EL) |
| Example 60 | 90 | 8 | 2 | 4(F05) | — | lauryl methacrylate | 6 | 9(EL) |
| Comp. Ex. 36 | 65 | 33 | 2 | 32(F05) | — | leaf alcohol | 6 | 10(N) |
| Comp. Ex. 37 | 65 | 33 | 2 | 10(F05) | — | leaf alcohol | 6 | 23(N) |
| Comp. Ex. 38 | 65 | 33 | 2 | — | 6(L) | leaf alcohol | 6 | 3(N) |
| Comp. Ex. 39 | 70 | 28 | 2 | 32(F05) | — | limonene | 6 | 10(N) |
| Comp. Ex. 40 | 70 | 28 | 2 | 10(F05) | — | limonene | 6 | 23(N) |
| Comp. Ex. 41 | 55 | 43 | 2 | 32(F05) | — | citral | 6 | 10(N) |
| Comp. Ex. 42 | 55 | 43 | 2 | 10(F05) | — | citral | 6 | 23(N) |
| Comp. Ex. 43 | 90 | 8 | 2 | 32(F05) | | lauryl methacrylate | 6 | 10(N) |
| Comp. Ex. 44 | 90 | 8 | 2 | 10(F05) | — | lauryl methacrylate | 6 | 23(N) |

*1 As the polyvinyl alcohol, “L” represents JL-05E having a degree of saponification of 82 mol %, and “F05” represents JF-05 having a degree of saponification of 98.5 mol %.
*2 As a hydrophilic substance, “N” represents NOIGEN XL-160, and “EL” represents PERSOFT EL.

TABLE 12

| | | | | | remaining amount of volatile active substance | | | | |
|---|---|---|---|---|---|---|---|---|---|
| | | | | | weight ratio relative to the initial amount | | | | |
| | | | | | | | | | the day when |
| | | glass transition | | | | | | | remaining |
| | molar ratio of | temperature | | evaporation | 20 | 40 | 60 | 90 | amount reached |
| | hydrophilic part | of polymer *3 | viscosity | residue | days | days | days | days | not more than 5% |
| | to acetate part | (° C.) | (mPa · s) | (%) | later *4 | later *4 | later *4 | later *4 | (day) |
| Example 57 | 76.3 | −6 | 90 | 40.1 | 68 | 49 | 36 | 28 | 200 |
| Example 58 | 84.6 | 0 | 85 | 41.8 | 64 | 45 | 31 | 23 | 167 |
| Example 59 | 94.0 | −14 | 80 | 41.8 | 67 | 47 | 33 | 24 | 178 |
| Example 60 | 81.6 | 18 | 90 | 39.4 | 70 | 51 | 39 | 28 | 202 |
| Comp. Ex. 36 | 66.7 | 6 | 80 | 33.3 | 39 | 21 | 13 | 10 | 111 |
| Comp. Ex. 37 | 73.6 | 6 | 85 | 37.6 | 42 | 23 | 15 | 11 | 117 |
| Comp. Ex. 38 | 4.7 | 6 | 75 | 39.8 | 38 | 21 | 12 | 10 | 110 |
| Comp. Ex. 39 | 66.7 | 0 | 80 | 35.6 | 41 | 22 | 12 | 9 | 104 |
| Comp. Ex. 40 | 73.6 | 0 | 75 | 40.9 | 43 | 23 | 15 | 10 | 114 |
| Comp. Ex. 41 | 66.7 | −14 | 70 | 35.3 | 37 | 19 | 12 | 8 | 100 |
| Comp. Ex. 42 | 73.6 | −14 | 70 | 40.8 | 39 | 22 | 12 | 10 | 108 |
| Comp. Ex. 43 | 66.7 | 18 | 80 | 34.7 | 40 | 20 | 12 | 11 | 113 |
| Comp. Ex. 44 | 73.6 | 18 | 85 | 39.0 | 39 | 20 | 11 | 10 | 105 |

*3 value obtained by calculation based on equation (1).
*4 weight ratio relative to the initial amount which is regarded as 100.

TABLE 13

| | polymerization step | | | | | | after polymerization | | | | |
|---|---|---|---|---|---|---|---|---|---|---|---|
| | (part by weight) | | | | | | (part by weight) | | | | |
| | monomer | | | polyvinyl | polyvinyl | | volatile | | polyvinyl | polyvinyl | |
| | vinyl | butyl | acrylic | alcohol | alcohol | hydrophilic | active | | alcohol | alcohol | hydrophilic |
| | acetate | acrylate | acid | (C1) *1 | (C2) *1 | substance *2 | substance | | (C1) *1 | (C2) *1 | substance *2 |
| Example 61 | 55 | 43 | 2 | — | — | 5(N) | leaf alcohol | 6 | 10(P) | — | — |
| Example 62 | 70 | 28 | 2 | — | — | 5(N) | limonene | 6 | 10(P) | — | — |
| Example 63 | 65 | 33 | 2 | — | — | 5(N) | citral | 6 | 10(P) | — | — |
| Example 64 | 70 | 28 | 2 | — | — | 5(N) | diazinon | 6 | 10(P) | — | — |
| Example 65 | 70 | 28 | 2 | — | — | 5(N) | lauryl | 6 | 10(P) | — | — |
| | | | | | | | methacrylate | | | | |
| Example 66 | 70 | 28 | 2 | 10(P) | — | — | lauryl | 6 | — | — | 5(EL) |
| | | | | | | | methacrylate | | | | |
| Example 67 | 55 | 43 | 2 | 5(P) | — | 5(N) | leaf alcohol | 6 | — | — | — |
| Example 68 | 70 | 28 | 2 | 5(P) | — | 5(N) | limonene | 6 | — | — | — |
| Example 69 | 65 | 33 | 2 | 5(P) | — | 5(N) | citral | 6 | — | — | — |
| Example 70 | 70 | 28 | 2 | 5(P) | — | 5(N) | diazinon | 6 | — | — | — |
| Example 71 | 70 | 28 | 2 | 5(P) | — | 5(N) | lauryl | 6 | — | — | — |
| | | | | | | | methacrylate | | | | |
| Example 72 | 55 | 43 | 2 | — | — | 5(N) | leaf alcohol | 6 | — | 5(T) | — |
| Example 73 | 70 | 28 | 2 | — | — | 5(N) | limonene | 6 | — | 5(T) | — |
| Example 74 | 65 | 33 | 2 | — | — | 5(N) | citral | 6 | — | 5(T) | — |
| Example 75 | 70 | 28 | 2 | — | — | 5(N) | diazinon | 6 | — | 5(T) | — |
| Example 76 | 70 | 28 | 2 | — | 10(T) | — | diazinon | 6 | — | — | 5(EL) |
| Example 77 | 70 | 28 | 2 | — | — | 5(N) | lauryl | 6 | — | 5(T) | — |
| | | | | | | | methacrylate | | | | |
| Example 78 | 55 | 43 | 2 | — | 5(T) | 5(N) | leaf alcohol | 6 | — | — | — |
| Example 79 | 70 | 28 | 2 | — | 5(T) | 5(N) | limonene | 6 | — | — | — |
| Example 80 | 65 | 33 | 2 | — | 5(T) | 5(N) | citral | 6 | — | — | — |
| Example 81 | 70 | 28 | 2 | — | 5(T) | 5(N) | diazinon | 6 | — | — | — |
| Example 82 | 70 | 28 | 2 | — | 5(T) | 5(N) | lauryl | 6 | — | — | — |
| | | | | | | | methacrylate | | | | |

*1 As the polyvinyl alcohol, “P” represents JP-05 having a degree of saponification of 88 mol %, “T” represents JT-05 having a degree of saponification of 94 mol %, and “F05” represents JF-05 having a degree of saponification of 98.5 mol %.
*2 As a hydrophilic substance, “EL” represents PERSOFT EL (active ingredient part), and “N” represents NOIGEN XL-160 (active ingredient part).

TABLE 14

| | | | | | | remaining amount of volatile active substance | | | | |
|---|---|---|---|---|---|---|---|---|---|---|
| | | | | | | weight ratio relative to the initial amount | | | | |
| | | | | | | | | | | the day when |
| | | glass transition | | | | | | | | remaining amount |
| | molar ratio of | temperature | | evaporation | | 20 | 40 | 60 | 90 | reached |
| | hydrophilic part | of polymer *3 | viscosity | residue | weather | days | days | days | days | not more than 5% |
| | to acetate part | (° C.) | (mPa · s) | (%) | resistance | later *4 | later *4 | later *4 | later *4 | (day) |
| Example 61 | 7.6 | 4 | 35 | 39.6 | — | 65 | 44 | 31 | 24 | 179 |
| Example 62 | 7.6 | 0 | 30 | 38.9 | — | 66 | 44 | 32 | 25 | 180 |
| Example 63 | 7.6 | −6 | 35 | 39.6 | — | 61 | 40 | 28 | 19 | 160 |
| Example 64 | 7.6 | 0 | 35 | 39.7 | High | 67 | 46 | 35 | 25 | 178 |
| Example 65 | 7.6 | 0 | 35 | 39.5 | — | 62 | 41 | 28 | 20 | 162 |
| Example 66 | 7.8 | 0 | 55 | 40.2 | — | 64 | 40 | 25 | 16 | 153 |
| Example 67 | 7.8 | 4 | 40 | 39.8 | — | 59 | 37 | 24 | 12 | 150 |
| Example 68 | 7.8 | 0 | 40 | 40.0 | — | 61 | 40 | 28 | 20 | 160 |
| Example 69 | 7.8 | −6 | 45 | 40.2 | — | 57 | 35 | 22 | 10 | 142 |
| Example 70 | 7.8 | 0 | 40 | 39.9 | High | 62 | 40 | 26 | 18 | 158 |
| Example 71 | 7.8 | 0 | 40 | 39.7 | — | 61 | 39 | 27 | 18 | 156 |
| Example 72 | 16.6 | 4 | 35 | 39.1 | — | 66 | 46 | 34 | 25 | 178 |
| Example 73 | 16.6 | 0 | 35 | 39.7 | — | 68 | 45 | 30 | 19 | 157 |
| Example 74 | 16.6 | −6 | 30 | 39.5 | — | 68 | 47 | 35 | 26 | 177 |
| Example 75 | 16.6 | 0 | 30 | 39.5 | High | 62 | 40 | 29 | 22 | 165 |
| Example 76 | 16.6 | 0 | 60 | 40.6 | High | 65 | 44 | 31 | 22 | 164 |
| Example 77 | 16.6 | 0 | 35 | 39.4 | — | 65 | 43 | 30 | 21 | 165 |
| Example 78 | 16.6 | 4 | 45 | 39.9 | — | 66 | 47 | 35 | 28 | 191 |
| Example 79 | 16.6 | 0 | 40 | 40.2 | — | 69 | 47 | 32 | 24 | 176 |
| Example 80 | 16.6 | −6 | 50 | 40.1 | — | 64 | 43 | 32 | 24 | 179 |
| Example 81 | 16.6 | 0 | 45 | 40.6 | High | 65 | 43 | 31 | 22 | 175 |
| Example 82 | 16.6 | 0 | 45 | 40.1 | — | 65 | 42 | 31 | 23 | 176 |

*3 value obtained by calculation based on equation (1).
*4 weight ratio relative to the initial amount which is regarded as 100.

TABLE 15

| | polymerization step | | | | | after polymerization | | | |
|---|---|---|---|---|---|---|---|---|---|
| | (part by weight) | | | | | (part by weight) | | | |
| | monomer | | | polyvinyl | | volatile | | polyvinyl | |
| | vinyl | butyl | acrylic | alcohol | hydrophilic | active | | alcohol | hydrophilic |
| | acetate | acrylate | acid | (C3) *1 | substance *2 | substance | | (C3) *1 | substance *2 |
| Example 83 | 55 | 43 | 2 | — | 5(N) | leaf alcohol | 6 | 10(F05) | — |
| Example 84 | 70 | 28 | 2 | — | 5(N) | limonene | 6 | 10(F05) | — |
| Example 85 | 65 | 33 | 2 | — | 5(N) | citral | 6 | 10(F05) | — |
| Example 86 | 70 | 28 | 2 | — | 5(N) | diazinon | 6 | 10(F05) | — |
| Example 87 | 70 | 28 | 2 | 10(F05) | — | diazinon | 6 | — | 5(EL) |
| Example 88 | 70 | 28 | 2 | — | 5(N) | lauryl methacrylate | 6 | 10(F05) | — |
| Example 89 | 55 | 43 | 2 | 10(F05) | 5(N) | leaf alcohol | 6 | — | — |
| Example 90 | 70 | 28 | 2 | 10(F05) | 5(N) | limonene | 6 | — | — |
| Example 91 | 65 | 33 | 2 | 10(F05) | 5(N) | citral | 6 | — | — |
| Example 92 | 70 | 28 | 2 | 10(F05) | 5(N) | diazinon | 6 | — | — |
| Example 93 | 70 | 28 | 2 | 10(F05) | 5(N) | lauryl methacrylate | 6 | — | — |

*1 As the polyvinyl alcohol, “P” represents JP-05 having a degree of saponification of 88 mol %, “T” represents JT-05 having a degree of saponification of 94 mol %, and “F05” represents JF-05 having a degree of saponification of 98.5 mol %.
*2 As a hydrophilic substance, “EL” represents PERSOFT EL (active ingredient part), and “N” represents NOIGEN XL-160 (active ingredient part).

TABLE 16

| | | | | | | remaining amount of volatile active substance | | | | |
|---|---|---|---|---|---|---|---|---|---|---|
| | | | | | | weight ratio relative to the initial amount | | | | |
| | | | | | | | | | | the day when |
| | | glass transition | | | | | | | | remaining amount |
| | molar ratio of | temperature | | evaporation | | 20 | 40 | 60 | 90 | reached |
| | hydrophilic part | of polymer *3 | Viscosity | residue | weather | days | days | days | days | not more than 5% |
| | to acetate part | (° C.) | (mPa · s) | (%) | resistance | later *4 | later *4 | later *4 | later *4 | (day) |
| Example 83 | 67.4 | 4 | 35 | 39.2 | — | 59 | 36 | 21 | 10 | 143 |
| Example 84 | 67.4 | 0 | 30 | 38.7 | — | 59 | 35 | 19 | 9 | 141 |
| Example 85 | 67.4 | −6 | 35 | 39.4 | — | 57 | 35 | 20 | 10 | 139 |
| Example 86 | 67.4 | 0 | 30 | 39.4 | High | 60 | 36 | 20 | 10 | 143 |
| Example 87 | 69.2 | 0 | 55 | 40.2 | — | 66 | 43 | 29 | 19 | 156 |
| Example 88 | 67.4 | 0 | 30 | 39.1 | — | 62 | 38 | 22 | 11 | 145 |
| Example 89 | 67.4 | 4 | 50 | 40.3 | — | 63 | 41 | 32 | 26 | 180 |
| Example 90 | 67.4 | 0 | 60 | 40.0 | — | 62 | 40 | 30 | 24 | 180 |
| Example 91 | 67.4 | −6 | 65 | 40.0 | — | 65 | 42 | 28 | 20 | 163 |
| Example 92 | 67.4 | 0 | 60 | 40.2 | High | 62 | 39 | 30 | 25 | 181 |
| Example 93 | 67.4 | 0 | 55 | 40.1 | — | 62 | 40 | 29 | 23 | 177 |

*3 value obtained by calculation based on equation (1).
*4 weight ratio relative to the initial amount which is regarded as 100.

Having thus described certain embodiments of the present invention, it is to be understood that the invention defined by the appended claims is not to be limited by particular details set forth in the above description as many apparent variations thereof are possible without departing from the spirit or scope thereof as hereinafter claimed.

What is claimed is:

1. A sustained release preparation comprising:
a water dispersion having viscosity at 25° C. of not more than 100 mPa·s and comprising:
polymer particles which are obtained by polymerizing ethylenically unsaturated group-containing monomers (A),
at least one kind of a hydrophilic substance (B) in an amount of more than 0% by weight but not more than 20% by weight relative to a total amount of the ethylenically unsaturated group-containing monomers (A), being selected from a group consisting of a surfactant, a plasticizer and a moisturizer,
polyvinyl alcohol (C) in an amount of more than 0% by weight but not more than 30% by weight relative to the total amount of the ethylenically unsaturated group-containing monomers (A), having a degree of saponification of more than 82 mol %, and water, and
a volatile active substance which is selected from a group consisting of a pheromone substance, an agricultural chemical, an aromatic, a deodorant and an antibacterial agent.

2. The sustained release preparation according to claim 1, wherein the polyvinyl alcohol (C) is selected from a group consisting of polyvinyl alcohol (C1) having a degree of saponification of more than 82 mol % but not more than 91.5 mol %, polyvinyl alcohol (C2) having a degree of saponification of more than 91.5 mol % and less than 98 mol %, and polyvinyl alcohol (C3) having a degree of saponification of not less than 98 mol %.

3. The sustained release preparation according to claim 2, wherein a ratio of a molar amount of hydrophilic part to a molar amount of acetate part is not more than 15.0 when the polyvinyl alcohol (C) is the polyvinyl alcohol (C1), not more than 40.0 when the polyvinyl alcohol (C) is the polyvinyl alcohol (C2), and not more than 90.0 when the polyvinyl alcohol (C) is the polyvinyl alcohol (C3), the molar amount of hydrophilic part being a total mole of vinyl alcohol monomer units in the polyvinyl alcohol (C) and the hydrophilic substance (B), and the molar amount of acetate part being a total mole of vinyl acetate monomer units in the polyvinyl alcohol (C) in a total amount of the polyvinyl alcohol (C) and the hydrophilic substance (B).

4. The sustained release preparation according to claim 1, wherein the volatile active substance is in an amount of from 3% by weight to 20% by weight relative to the ethylenically unsaturated group-containing monomers (A) comprised by the water dispersion.

5. The sustained release preparation according to claim 1, wherein the volatile active substance is selected from a group consisting of acetate, alcohol (including phenol), epoxide, alkane, alkene, aldehyde, ketone, carboxylic acid, ester and ether, each having a boiling point from 100° C. to 350° C. and having six to twenty carbon atoms.

6. A method for producing a sustained release preparation comprising:
a polymerization step of emulsion-polymerizing ethylenically unsaturated group-containing monomers (A) in the presence of a hydrophilic substance (B) and/or polyvinyl alcohol (C) to obtain a polymer particle water dispersion having viscosity at 25° C. of not more than 100 mPa·s,
wherein the polyvinyl alcohol (C) is selected from a group consisting of polyvinyl alcohol (C1) having a degree of saponification of more than 82 mol % but not more than 91.5 mol %, polyvinyl alcohol (C2) having a degree of saponification of more than 91.5 mol % but less than 98 mol %, and polyvinyl alcohol (C3) having a degree of saponification of not less than 98 mol %, and
wherein both of the hydrophilic substance (B) and the polyvinyl alcohol (C) are present during the polymerization, or one of the hydrophilic substance (B) and the polyvinyl alcohol (C) is present during the polymerization and the other of the hydrophilic substance (B) and the polyvinyl alcohol (C), which is not present during the polymerization, is blended after the polymerization, or the polyvinyl alcohol (C) and one portion of the hydrophilic substance (B) are present during the polymerization and the other portion of the hydrophilic substance (B) is blended after the polymerization,
so that the hydrophilic substance (B) is in an amount of more than 0% by weight but not more than 20% by weight relative to the total amount of the ethylenically unsaturated group-containing monomers (A) and the polyvinyl alcohol (C) is in an amount of more than 0% by weight but not more than 30% by weight relative to a total amount of the ethylenically unsaturated group-containing monomers (A), and
a mixing step of mixing the polymer particle water dispersion with a volatile active substance selected from a group consisting of a pheromone substance, an agricultural chemical, an aromatic, a deodorant and an antibacterial agent.

7. The method for producing a sustained release preparation according to claim 6, wherein the hydrophilic substance (B) is present during the polymerization and the polyvinyl alcohol (C) is blended after the polymerization, or the polyvinyl alcohol (C) is present during the polymerization and the hydrophilic substance (B) is blended after the polymerization.

8. The method for producing a sustained release preparation according to claim 6, wherein all of the hydrophilic substance (B) and the polyvinyl alcohol (C) are present during the polymerization.

9. The manufacturing method of a sustained release preparation according to claim 6, wherein the polyvinyl alcohol (C) and one portion of the hydrophilic substance (B) are present during the polymerization and the other portion of the hydrophilic substance (B) is blended after the polymerization.
